(19) United States
(12) Patent Application Publication
(10) Pub. No.: US 2025/0313088 A1
(43) Pub. Date: Oct. 9, 2025

(54) METER PANEL UNIT AND WORK VEHICLE

(71) Applicant: Kubota Corporation, Osaka (JP)

(72) Inventors: Wataru SASAKI, Sakai-shi (JP); Manabu TOGO, Sakai-shi (JP); Junichi IKEHATA, Sakai-shi (JP)

(21) Appl. No.: 19/243,193

(22) Filed: Jun. 19, 2025

Related U.S. Application Data
(63) Continuation of application No. PCT/JP2023/043437, filed on Dec. 5, 2023.

(30) Foreign Application Priority Data
Dec. 26, 2022 (JP) 2022-208211
Dec. 26, 2022 (JP) 2022-208214
Dec. 26, 2022 (JP) 2022-208215

(51) Int. Cl. B60K 35/215; B60K 35/50; B60K 37/20; B62D 49/06

(52) U.S. Cl. CPC B60K 35/215; B60K 35/50; B60K 37/20; B60K 2360/1523; B62D 49/06

(57) ABSTRACT

A meter panel unit for a work vehicle includes a meter portion including a first analog meter and a second analog meter each including a pointer, and a display between the first and second analog meters, a wall surface provided on a display surface side of the meter portion to surround the first and second analog meters and the display, and a transparent cover opposite a display surface of the meter portion. The wall surface includes a visor region positioned above the analog meters and the display. The transparent cover includes a concave surface.

### CROSS REFERENCE TO RELATED APPLICATIONS

This application claims the benefit of priority to Japanese Patent Application Nos. 2022-208211, 2022-208214 and 2022-208215 filed on Dec. 26, 2022 and is a Continuation Application of PCT Application No. PCT/JP2023/043437 filed on Dec. 5, 2023. The entire contents of each application are hereby incorporated herein by reference.

### BACKGROUND OF THE INVENTION

### 1. Field of the Invention

The present disclosure relates to meter panels, information display systems, and work vehicles.

### 2. Description of the Related Art

Research and development of smart agriculture that uses information and communication technology (ICT) and the Internet of things (IoT), as the next-generation agriculture, is under way. Automated and unmanned operations of agricultural machines such as tractors used in fields have been studied and developed. For example, work vehicles that travel while performing automatic steering, using a positioning system such as a global navigation satellite system (GNSS) that can perform precise positioning, have been put into practice.

A meter panel unit that displays and notifies an operator of a travel speed, the load state of an engine, and the state of each portion of a work vehicle is provided in front of the operator's seat of an agricultural machine (work vehicle) such as a tractor. Japanese Laid-Open Patent Publication No. 2012-32209 describes a commonly used meter unit for passenger cars.

### SUMMARY OF THE INVENTION

A meter panel provided in an agricultural machine such as a tractor is desired to accurately notify the operator of various kinds of information about the vehicle when the vehicle is traveling or working. In addition, it is necessary to display more kinds of information in order to allow such an agricultural machine to perform various kinds of works outdoors compared to general passenger cars. In the case in which an agricultural machine is used in smart agriculture, even more kinds of information are desired to be displayed. However, as the amount of information displayed on the meter panel increases, visibility decreases, and therefore, it is more difficult for the operator to obtain necessary information.

There is an increased demand for such a meter panel not only for agricultural machines but also construction machines that are used in work in construction sites. Agricultural machines and construction machines that can travel are hereinafter collectively referred to as “work vehicles.”

Example embodiments of the present disclosure provide meter panel units, and work vehicles including such meter panel units.

The present disclosure provides solutions described in the following items.

### [Item A1]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, arc-shaped indicators positioned around sweep ranges of the respective pointers, and facing plates positioned outward of the respective arc-shaped indicators, wherein each of the arc-shaped indicators includes at least one light emitting region between the sweep range of the respective pointer and the respective facing plate.

### [Item A2]

The meter panel unit of Item A1, wherein the arc-shaped indicator includes one or more light emitting regions in which light beams with different colors are emitted.

### [Item A3]

The meter panel unit of Item A1 or A2, wherein each of the arc-shaped indicators and each of the facing plates are provided on the respective one of both sides of the display, and the arc-shaped indicators and the facing plates are positioned outward of a region between a straight line forming a boundary between the first analog meter and the display and a straight line forming a boundary between the second analog meter and the display.

### [Item A4]

An information display system including the meter panel unit of Item A2 or A3, and a controller configured or programmed to control the meter panel unit, wherein the controller is configured or programmed to cause the arc-shaped indicator to display information before causing the display to display information during starting of the work vehicle.

### [Item A5]

The information display system of Item A4, wherein the information includes a content indicating a state of the work vehicle.

### [Item A6]

The information display system of Item A5, wherein the controller is configured or programmed to change a color of light according to a content of the information.

### [Item A7]

The information display system of Item A6, wherein the controller is configured or programmed to change the color of the light to red when a state of the work vehicle is classified as being abnormal for travel or work.

### [Item A8]

A work vehicle including the meter panel unit of any one of Items A1 to A3.

### [Item A9]

A work vehicle including the information display system of any one of Items A4 to A7.

### [Item B1]

An information display system including a meter panel unit for a work vehicle, and a controller configured or programmed to control the meter panel unit, wherein the meter panel unit includes a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and arc-shaped indicators positioned around sweep ranges of the respective pointers, each of the arc-shaped indicators includes at least one light emitting region with a shape of an arc, and the controller is configured or programmed to cause the display to display a curved line-shaped image on an extension line of the arc.

### [Item B2]

The information display system of Item B1 including facing plates positioned outward of the respective arc-shaped indicators.

### [Item B3]

The information display system of Item B1 or B2, wherein the controller is configured or programmed to cause the display to display a curved line-shaped image on an extension line of the arc shape using light with a same color as that of light emitted from the plurality of light emitting regions.

### [Item B4]

The information display system of Item B1 or B2, wherein the controller is configured or programmed to synchronize changes in luminance of an image displayed on the display with a flicker of light emitted from the light emitting region.

### [Item B5]

The information display system of Item B1 or B2, wherein each of the arc-shaped indicators is provided on the respective one of both sides of the display, and the controller is configured or programmed to cause the display to display a straight line portion connected to an arc with a same center as that of the arc shape and parallel with a straight line forming a boundary between the first analog meter and the display and a straight line forming a boundary between the second analog meter and the display.

### [Item B6]

A work vehicle including the information display system of any one of Items B1 to B5.

### [Item C1]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, arc-shaped indicators positioned around sweep ranges of the respective pointers, and facing plates positioned outward of the respective arc-shaped indicators, wherein each of the arc-shaped indicators includes a light emitting region between the sweep range of the respective pointer and the respective facing plate, and each of the facing plates includes a reflective surface configured to reflect light emitted from the light emitting region toward an operator of the work vehicle.

### [Item C2]

The meter panel unit of Item C1, wherein a height of the facing plate from the meter portion is greatest at a lateral position with respect to a middle portion of the arc-shaped indicator, and decreases toward both ends of the facing plate along the arc-shaped indicator.

### [Item C3]

The meter panel unit of Item C2, wherein a greatest value of the height is at least about 30 mm.

### [Item C4]

The meter panel unit of Item C3, wherein the wall surface includes a visor region positioned above the analog meters and the display with the wall surface attached to the work vehicle, and a height of the visor region from the meter portion is at least about 40 mm.

### [Item C5]

The meter panel unit of Item C2, wherein the wall surface includes a visor region positioned above the analog meters and the display with the wall surface attached to the work vehicle, and a height of the visor region from the meter portion is greater than a height of the facing plate from the meter portion.

### [Item C6]

The meter panel unit of Item C4 or C5, wherein with the meter panel unit attached to the work vehicle, the transparent cover is tilted toward the operator of the work vehicle as viewed from a normal direction of the meter portion.

### [Item C7]

A work vehicle including the meter panel unit of any one of Items C1 to C6.

### [Item D1]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, arc-shaped indicators positioned around sweep ranges of the respective pointers, and facing plates positioned outward of the respective arc-shaped indicators, wherein each of the arc-shaped indicators includes at least one light emitting region between the sweep range of the respective pointer and the respective facing plate, and each analog meter includes an arc-shaped scale between the respective arc-shaped indicator and the sweep range of the respective pointer.

### [Item D2]

The meter panel unit of Item D1, wherein each of the arc-shaped indicators and each of the facing plates are provided on the respective one of both sides of the display, and the arc-shaped indicators and the facing plates are positioned outward of a region interposed between a straight line forming a boundary between the first analog meter and the display and a straight line forming a boundary between the second analog meter and the display.

### [Item D3]

The meter panel unit of Item D1, wherein the scale is a raised scale protruding from the display surface.

### [Item D4]

The meter panel unit of Item D3, wherein the wall surface, the facing plates, and the scale are integrally formed of a resin.

### [Item D5]

The meter panel unit of Item D4, wherein the scale includes a plurality of notches positioned at predetermined intervals.

### [Item D6]

A work vehicle including the meter panel unit of any one of Items D1 to D5.

### [Item D7]

A meter panel unit for a work vehicle including a meter portion including a first analog meter including a first pointer, a second analog meter including second and third pointers, and a display between the first and second analog meters, a wall surface provided on a display surface side of the meter portion to surround the first and second analog meters and the display, a transparent cover opposite a display surface of the meter portion, a first arc-shaped indicator positioned around a sweep range of the first pointer, a second arc-shaped indicator positioned around a sweep range of the second and third pointers, and a pair of facing plates positioned outward of the first and second arc-shaped indicators, respectively, wherein each of the first and second arc-shaped indicators includes at least one light emitting region between the sweep range of the respective pointer and the respective facing plate, and an outer shape of a movement range of the second pointer and an outer shape of a movement range of the third pointer are similar or congruent to each other.

### [Item D8]

The meter panel unit of Item D7, wherein the outer shape of the movement range of the second pointer and the outer shape of the movement range of the third pointer are vertically symmetric.

### [Item D9]

The meter panel unit of Item D7, wherein the movement range of the second pointer and the movement range of the third pointer have such a shape and size that the movement ranges match each other when one of the movement ranges is translated in a vertical direction.

### [Item D10]

The meter panel unit of any one of Items D7 to D9, wherein the second pointer indicates a remaining amount of fuel of the work vehicle, and the third pointer indicates a temperature of engine cooling water of the work vehicle.

### [Item E1]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, arc-shaped indicators positioned around sweep ranges of the respective pointers, and facing plates positioned outward of the respective arc-shaped indicators, wherein each of the first and second analog meters includes an arc-shaped scale between the respective arc-shaped indicator and the sweep range of the respective pointer, and each of the facing plates includes a plurality of protrusions protruding toward the sweep range of the respective pointer, and the plurality of protrusions are aligned with the scales.

### [Item E2]

The meter panel unit of Item E1, wherein the arc-shaped indicator includes at least one light emitting region between the sweep range of the pointer and the facing plate, and the plurality of protrusions of the facing plate extend across a respective one of spaces between the light emitting regions.

### [Item E3]

The meter panel unit of Item E1, wherein the scale is a raised scale protruding from the display surface.

### [Item E4]

The meter panel unit of Item E3, wherein the plurality of protrusions connect the facing plate to the raised scale.

### [Item E5]

The meter panel unit of Item E4, wherein the wall surface, the facing plates, and the raised scale are integrally formed of a resin.

### [Item E6]

The meter panel unit of Item E4, wherein a plurality of protrusions form boundaries between the light emitting regions in the arc-shaped indicator.

### [Item E7]

A work vehicle including the meter panel unit of any one of Items E1 to E6.

### [Item F1]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, and a transparent cover opposite a display surface of the meter portion, wherein the wall surface includes a visor region positioned above the first and second analog meters and the display, and the transparent cover includes a concave surface.

### [Item F2]

The meter panel unit of Item F1, wherein the transparent cover includes a front surface section including the concave surface, and a side surface section extending from the front surface section along an outer side of the wall surface.

### [Item F3]

The meter panel unit of Item F2, wherein the side surface section of the transparent cover covers an outer side of the wall surface around an entire periphery thereof.

### [Item F4]

The meter panel unit of Item F1, wherein with the meter panel unit attached to the work vehicle, the transparent cover is tilted toward an operator of the work vehicle as viewed from a normal direction of the meter portion.

### [Item F5]

The meter panel unit of Item F1, wherein the concave surface of the transparent cover has a uniform curvature in each of a horizontal direction and a vertical direction orthogonal to the horizontal direction.

### [Item F6]

The meter panel unit of any one of Items F1 to F5, wherein a height of the visor region from the meter portion is at least about 40 mm.

### [Item F7]

A work vehicle including the meter panel unit of any one of Items F1 to F6.

### [Item G1]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and an indicator region in which a plurality of indicators are positioned, wherein the plurality of indicators includes a group of indicators to each of which two light emitting devices are assigned.

### [Item G2]

The meter panel unit of Item G1, wherein the indicator region includes two separate portions, and the group of indicators is positioned in one of the two separate portions, and a second group of indicators to each of which a single light emitting device is assigned are positioned in the other separate portion.

### [Item G3]

The meter panel unit of Item G2, wherein the group of indicators includes an indicator with a relatively large size, and the second group of indicators includes an indicator having a relatively small size smaller than the relatively large size.

### [Item G4]

A work vehicle including the meter panel unit of any one of Items G1 to G3.

### [Item G5]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and an indicator region provided below the display and including two portions separated from each other in a horizontal direction.

### [Item G6]

The meter panel unit of Item G5 including a second indicator region provided above the display.

### [Item G7]

The meter panel unit of Item G6, wherein a warning level of information indicated by an indicator positioned in the second indicator region is higher than a warning level of information indicated by an indicator positioned in the indicator region.

### [Item G8]

The meter panel unit of Item G7, wherein the indicator region includes an empty region in which an indicator is not positioned, in a vicinity of a boundary between the two portions.

### [Item G9]

The meter panel unit of Item G8, wherein the empty region extends across the boundary between the two portions.

### [Item G10]

A work vehicle including the meter panel unit of any one of Items G5 to G9.

### [Item H1]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and an illuminance sensor provided below the display.

### [Item H2]

The meter panel unit of Item H1, wherein the wall surface includes a visor region positioned above the first and second analog meters and the display.

### [Item H3]

The meter panel unit of Item H1, wherein a non-light-emitting region with a horizontal width of at least about 5 mm is provided on either side of the illuminance sensor.

### [Item H4]

The meter panel unit of Item H1 including arc-shaped indicators positioned around sweep ranges of the respective pointers, and facing plates positioned outward of the respective arc-shaped indicators, wherein each of the arc-shaped indicators includes at least one light emitting region between the sweep range of the respective pointer and the respective facing plate, and the meter panel unit is configured to change a brightness of the light emitting region of each of the arc-shaped indicators according to an output from the illuminance sensor.

### [Item H5]

The meter panel unit of Item H1, wherein the meter panel unit is configured to change the brightness of the display according to an output from the illuminance sensor.

### [Item H6]

A work vehicle including the meter panel unit of any one of Items H1 to H5.

### [Item H7]

A work vehicle including a meter panel unit, a headlamp, and a controller configured or programmed to control an on/off state of the headlamp, wherein the meter panel unit includes a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and an illuminance sensor, and the controller is configured or programmed to change a brightness of the headlamp according to an output from the illuminance sensor.

### [Item H8]

The work vehicle of Item H7, wherein the illuminance sensor is provided below the display.

### [Item H9]

The work vehicle of Item H7 or H8 including a work lamp, wherein the controller is further configured or programmed to change a brightness of the work lamp according to the output from the illuminance sensor.

### [Item H10]

The work vehicle of Item H9, wherein the controller is configured or programmed to cause the display to display a warning message that prompts an operator to turn off the headlamp and/or work lamp according to the output from the illuminance sensor.

### [Item I1]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and a rear cover positioned on a back surface side of the meter portion, wherein the rear cover includes at least one back surface connector with a connection direction tilted from a normal direction of the rear cover.

### [Item I2]

The meter panel unit of Item I1, wherein the at least one back surface connector is a connector configured to be connected to a camera cable, and a connection direction of the connector is orthogonal to a normal direction.

### [Item I3]

The meter panel unit of Item I2 including a cap configured to block a connection portion of the at least one back surface connector, wherein the rear cover is provided with a retention tether configured to connect the cap to the rear cover.

### [Item I4]

The meter panel unit of Item I3, wherein the cap is a rubber cap in the shape of a rib, and the retention tether is a rubber strap.

### [Item I5]

The meter panel unit of Item I3, wherein the rear cover is configured to be fitted with the transparent cover, and the retention tether is fixed to a fitting portion at which the rear cover is fitted with the transparent cover.

### [Item I6]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and a rear cover positioned on a back surface side of the meter portion, wherein the rear cover includes a binding section configured to bind up a plurality of wire harnesses.

### [Item I7]

The meter panel unit of Item I6, wherein the binding section is positioned at a center portion of the rear cover.

### [Item I8]

The meter panel unit of Item I6, wherein the rear cover and the binding section are integrally formed of a resin material.

### [Item I9]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and a rear cover positioned on a back surface side of the meter portion, wherein the rear cover includes at least one fixing section having a bolt hole into which a bolt to fix the transparent cover is inserted, and the at least one fixing section is positioned within a frame with a circumscribed rectangle that touches an outer shape of the meter panel unit.

### [Item I10]

The meter panel unit of Item I9, wherein the at least one fixing section includes four fixing sections protruding toward four corners of the circumscribed rectangle.

### [Item I11]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and a rear cover positioned on a back surface side of the meter portion, wherein the rear cover includes a surface including at least three protrusions protruding toward a back surface side, and tips of the at least three protrusions are positioned on a same plane, and configured to provide a predetermined space between the plane and the surface.

### [Item I12]

The meter panel unit of Item I11, wherein the rear cover and the protrusions are integrally formed of a resin material.

### [Item I13]

The meter panel unit of Item I11, wherein at least one electronic component is mounted on the surface of the rear cover, and a clearance of the predetermined space is greater than a height of the at least one electronic component.

### [Item I14]

A work vehicle including the meter panel unit of any one of Items I1 to I13.

### [Item J1]

A meter panel unit for a work vehicle, including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, a rear cover positioned on a back surface side of the meter portion, and a decorative ring provided along an edge of the transparent cover, wherein the decorative ring is fixed to the rear cover with the decorative ring on the transparent cover.

### [Item J2]

The meter panel unit of Item J1, wherein the decorative ring includes a front surface plated with a metal.

### [Item J3]

The meter panel unit of Item J1, wherein the rear cover includes at least one fixing section including a bolt hole into which a bolt to fix the decorative ring is inserted.

### [Item J4]

The meter panel unit of Item J3, wherein the at least one fixing section is positioned within a frame with a circumscribed rectangle that touches an outer shape of the meter panel unit.

### [Item J5]

The meter panel unit of Item J4, wherein the at least one fixing section includes four fixing sections protruding toward four corners of the circumscribed rectangle.

### [Item J6]

A meter panel unit for a work vehicle including a meter portion including a first analog meter and a second analog meter each including a pointer, and a display between the first and second analog meters, a wall surface provided on a display surface side of the meter portion to surround the first and second analog meters and the display, a transparent cover opposite a display surface of the meter portion, and a rear cover positioned on a back surface side of the meter portion, wherein the rear cover includes at least two fixing sections including a bolt hole into which a bolt to fix the transparent cover is inserted, and the bolt hole of one of the at least two fixing sections has a size and shape different from a size and a shape of the bolt holes of the other fixing sections.

### [Item J7]

The meter panel unit of Item J6, wherein the bolt hole of one of the at least two fixing sections has a size greater than that of the bolt in a predetermined direction, and the bolt holes of the other fixing sections have a size that fits a size of the bolt.

### [Item J8]

The meter panel unit of Item J6, wherein the at least two fixing sections include four fixing sections protruding toward the four corners of the circumscribed rectangle that touches an outer shape of the meter panel unit, and the bolt hole of one of the four fixing sections has an elliptical shape, and the bolt holes of the remaining three fixing sections have a circular shape.

### [Item J9]

A work vehicle including the meter panel unit of any one of Items J1 to J8.

General or specific example embodiments of the present disclosure may be implemented using a device, system, method, integrated circuit, computer program, non-transitory computer-readable storage medium, or any combination thereof. The computer-readable storage medium may be inclusive of volatile and non-volatile storage media. A device may include a plurality of devices. In the case in which a device includes two or more devices, the two or more devices may be provided in a single apparatus, or separately provided in two or more different apparatuses.

According to example embodiments of the present disclosure, meter panel units each capable of displaying various kinds of information required during agricultural work with high visibility, and vehicle including such meter panel units, are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a side view schematically illustrating a work vehicle according to an example embodiment of the present disclosure.

FIG. 1B is a front view schematically illustrating a meter panel unit attached behind a steering wheel positioned in front of an operator's seat of a work vehicle, in an example embodiment of the present disclosure.

FIG. 2 is a front view illustrating an example arrangement of main components of the meter panel unit of an example embodiment of the present disclosure.

FIG. 3 is a perspective view illustrating an example configuration of a wall surface of the meter panel unit of an example embodiment of the present disclosure.

FIG. 4 is a front view illustrating an example configuration of a transparent cover of the meter panel unit of an example embodiment of the present disclosure.

FIG. 5 is a front view illustrating an example arrangement of an indicator of the meter panel unit of an example embodiment of the present disclosure.

FIG. 6A is a front view illustrating an example state in which various kinds of information are displayed on a display of the meter panel unit of an example embodiment of the present disclosure.

FIG. 6B is a schematic diagram illustrating an example configuration of an indicator in an example embodiment of the present disclosure.

FIG. 6C is a schematic diagram illustrating another example configuration of an indicator in an example embodiment of the present disclosure.

FIG. 7A is a front view illustrating a detailed configuration of the meter panel unit of an example embodiment of the present disclosure.

FIG. 7B is a cross-sectional view taken along line B-B of FIG. 7A.

FIG. 7C is a cross-sectional view taken along line C-C of FIG. 7A.

FIG. 7D is a cross-sectional view taken along line D-D of FIG. 7A.

FIG. 8 is a perspective view of a meter panel unit of an example embodiment of the present disclosure.

FIG. 9 is a perspective view of an analog meter of a meter panel unit of an example embodiment of the present disclosure.

FIG. 10 is a front view illustrating a positional relationship between a first analog meter, an arc-shaped indicator, and a facing plate.

FIG. 11 is a front view illustrating an example configuration of an arc-shaped indicator.

FIG. 12 is a cross-sectional view taken along line IV-IV of FIG. 10.

FIG. 13 is a front view illustrating a second analog meter and a second arc-shaped indicator.

FIG. 14 is a block diagram schematically illustrating an example configuration of an information display system in an example embodiment of the present disclosure.

FIG. 15 is a front view schematically illustrating an example in which an arc having the same color as that of light emitted from a light emitting region of an arc-shaped indicator is displayed.

FIG. 16 is a front view schematically illustrating an example in which an arc having the same color as that of light emitted from a light emitting region of an arc-shaped indicator, and a second object having another shape and having an arc having the same color, are displayed.

FIG. 17 is a perspective view schematically illustrating an example decorative ring of a meter panel unit of an example embodiment of the present disclosure.

FIG. 18 is a perspective view illustrating a back surface of a meter panel unit of an example embodiment of the present disclosure.

FIG. 19 is another perspective view illustrating a back surface of a meter panel unit of an example embodiment of the present disclosure.

### DETAILED DESCRIPTION OF THE EXAMPLE EMBODIMENTS

Meter panel unit according to example embodiments of the present disclosure will be described below with reference to the accompanying drawings. It should be noted that like reference signs refer to like structural elements or features throughout the several views.

The example embodiments described below is exemplified to embody technical ideas of the present invention, and the present invention is not limited to the following. Furthermore, the descriptions of sizes, materials, shapes, relative arrangements, and the like of components are not intended to limit the scope of the present invention thereto but intended to be illustrative. The size and positional relationship of members illustrated in the drawings may be exaggerated to facilitate understanding.

As used herein, the term “parallel” with respect to two straight lines, sides, surfaces, or the like is intended to encompass some angular deviations from absolute parallelism between the two straight lines, sides, surfaces, or the like that are in the range of 0 to about 5°, for example, unless otherwise specified. As used herein, the term “perpendicular” or “orthogonal” with respect to two straight lines, sides, surfaces, or the like is intended to encompass some angular deviations from absolute perpendicularity or orthogonality (90°) between the two straight lines, sides, surfaces, or the like that are in the range of about ±5°, for example, unless otherwise specified. The angle between two straight lines, sides, surfaces, or the like has a positive value, but not a negative value, unless otherwise specified.

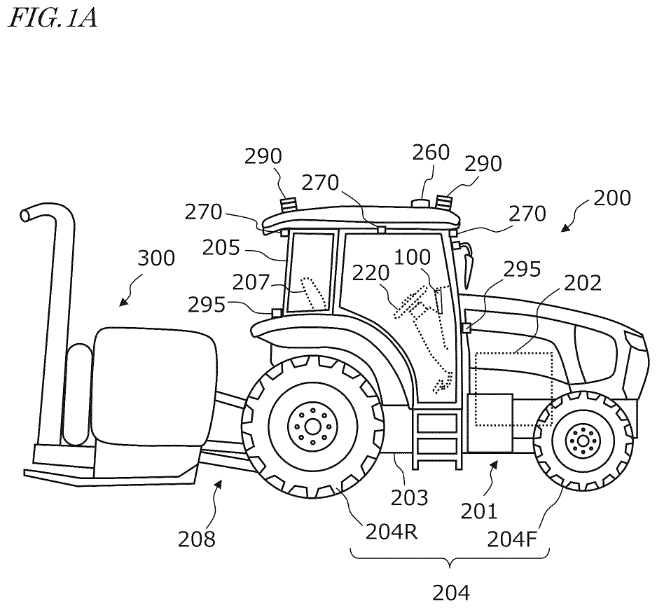

FIG. 1A is a side view schematically illustrating an example work vehicle 200 according to this example embodiment. The illustrated work vehicle 200 is a tractor that tows an implement (replaceable work equipment) 300.

The work vehicle 200 of FIG. 1A includes a vehicle body 201, a prime mover (engine) 202, and a transmission 203. The vehicle body 201 is provided with a travel device including tire-mounted wheels 204, and a cabin 205. The travel device includes four wheels 204, axles for rotating the four wheels, and brakes for slowing or stopping the axles. The wheels 204 of this example include a pair of front wheels 204F and a pair of rear wheels 204R. One or both of the front wheel 204F and the rear wheel 204R may be replaced by a plurality of wheels to which a continuous track is attached (crawler) instead of a tire-mounted wheel.

In the cabin 205, a meter panel unit 100 according to an example embodiment of the present disclosure, an operator's seat 207, a steering wheel 220, and switches for operations are provided.

The work vehicle 200 of FIG. 1A is provided with a plurality of external sensors to sense surroundings of the work vehicle 200. The external sensors may include various kinds of sensors such as a plurality of cameras 270, a plurality of obstacle sensors 295, and a plurality of LiDAR sensors 290. The cameras 270 may, for example, be provided on the front, rear, left, and right sides of the work vehicle 200. Each camera 270 captures an image of an environment around the work vehicle 200, and generates image data. Images obtained by the cameras 270 may, for example, be transmitted to a terminal device for remote monitoring. The cameras 270 are optionally provided, and the number thereof is not particularly limited. The LiDAR sensor 290 is an example external sensor to output sensor data indicating a distribution of objects present in an environment around the work vehicle 200. In the example of FIG. 1A, two LiDAR sensors 290 are provided at an upper front portion and an upper rear portion of the cabin 205. The LiDAR sensors 290 may be provided at other positions (e.g., a lower portion of a front surface of the vehicle body 201). Each LiDAR sensor 290 repeatedly outputs sensor data indicating distances to and directions of measurement points of objects existing in a surrounding environment, or the three-dimensional coordinate values of the measurement points, while the work vehicle 200 is traveling. The number of LiDAR sensors 290 is not limited to two and may be one or at least three. In the example of FIG. 1A, the plurality of obstacle sensors 295 are provided at a front portion and a rear portion of the cabin 205. The obstacle sensors 295 may be positioned at other positions. The obstacle sensors 295 may include a laser scanner or ultrasonic sonar, for example.

The work vehicle 200 further includes a GNSS unit 260. GNSS collectively refers to satellite-based positioning systems, such as the global positioning system (GPS), the quasi-zenith satellite system (QZSS, for example, Michibiki), GLONASS, Galileo, and BeiDou. The GNSS unit 260 receives satellite signals transmitted from a plurality of GNSS satellites (also referred to as GNSS signals), and performs positioning based on the satellite signals. Although the GNSS unit 260 is provided at an upper portion of the cabin 205, the GNSS unit 260 may be provided at other positions.

The engine 202 may, for example, be a diesel engine. An electric motor may be used instead of a diesel engine. The transmission 203 is capable of changing the propelling force and movement speed of the work vehicle 200 by changing gear ratios. The transmission 203 is also capable of allowing the work vehicle 200 to switch between forward movement and rearward movement.

A connecting device 208 is provided at a rear portion of the vehicle body 201. The connecting device 208 includes, for example, a three-point support device (also referred to as a “three-point linkage” or “three-point hitch”), a power take-off (PTO) shaft, a universal joint, and a communication cable. The connecting device 208 can be used to removably connect an implement 300 to the work vehicle 200. The connecting device 208 can change the position or orientation of the implement 300 by raising or lowering the three-point linkage using, for example, a hydraulic device. In addition, power can be transmitted from the work vehicle 200 to the implement 300 through the universal joint. While towing the implement 300, the work vehicle 200 allows the implement 300 to perform predetermined work. A connecting device may also be provided at a front portion of the vehicle body 201. In that case, an implement can be connected in front of the work vehicle 200.

Although the implement 300 of FIG. 1A is, for example, a sprayer for spraying a chemical agent to crop, the implement 300 is not limited to sprayers. For example, any kind of implement 300 such as a mower, seeder, spreader, rake implement, baler, harvester, plough, harrow, or rotary tiller may be connected to the work vehicle 200 for use.

Thus, the work vehicle 200, which is used in smart agriculture, is equipped with various sensors, and performs various kinds of work together with the implement 300. During such work, it is necessary to give the operator various kinds of information about a travel state and a work state. Therefore, information that should be displayed on the meter panel unit 100 may significantly vary depending on the kind and phase of work.

It should be noted that the work vehicle 200, such as a tractor, may be configured to travel by manual driving, automatic steering, or automatic driving.

FIG. 1B is a front view schematically illustrating the meter panel unit 100 when the meter panel unit 100 is attached to a tractor, which is an example work vehicle, in an example embodiment of the present disclosure. In the example illustrated in FIG. 1B, the meter panel unit 100 is positioned on the front side of the operator's seat of the tractor. Specifically, the meter panel unit 100 is positioned above a steering column (steering wheel stay) 230 that supports the steering wheel 220 in a manner that allows the steering wheel 220 to rotate, and is fitted into an opening of a meter cover 240. In this example, the steering wheel 220 includes a central hub (horn cover) 221, three spokes 222A, 222B, and 222C radially extending from the horn cover 221, and a rim 223 supported by the spokes 222A, 222B, and 222C. The meter panel unit 100 is provided at a position that allows the operator sitting on the operator's seat to see the meter panel unit 100. In the example of FIG. 1B, various kinds of information displayed on the meter panel unit 100 can be seen through an opening between the spokes 222A and 222B.

The meter panel unit 100 preferably has excellent visibility. In particular, in the case of movable work vehicles capable of performing automatic steering or automatic driving, various kinds of information that are not displayed on general passenger cars need to be displayed during various kinds of agricultural work. For the meter panel unit 100, having such a feature, the visibility is preferably improved so as to avoid overlooking more important information of various kinds of information. In addition, in the case in which the meter panel unit 100 is mounted on various work vehicles, it is desirable that the meter panel unit 100 have a structure that allows easy attachment. As described below, the meter panel unit 100 of this example embodiment has excellent visibility and is easy to attach.

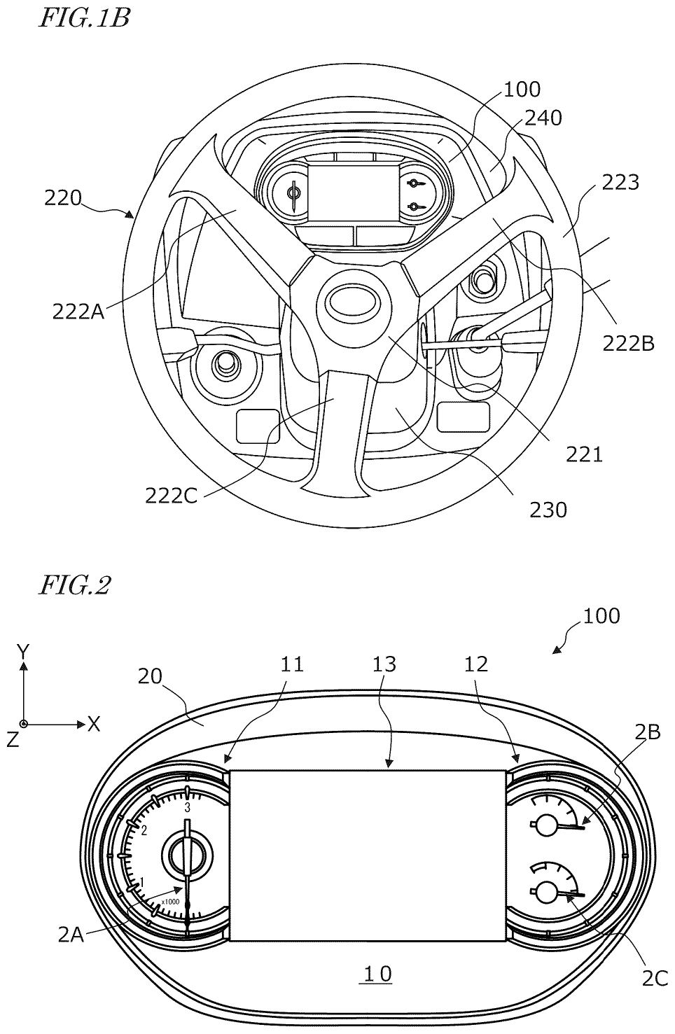

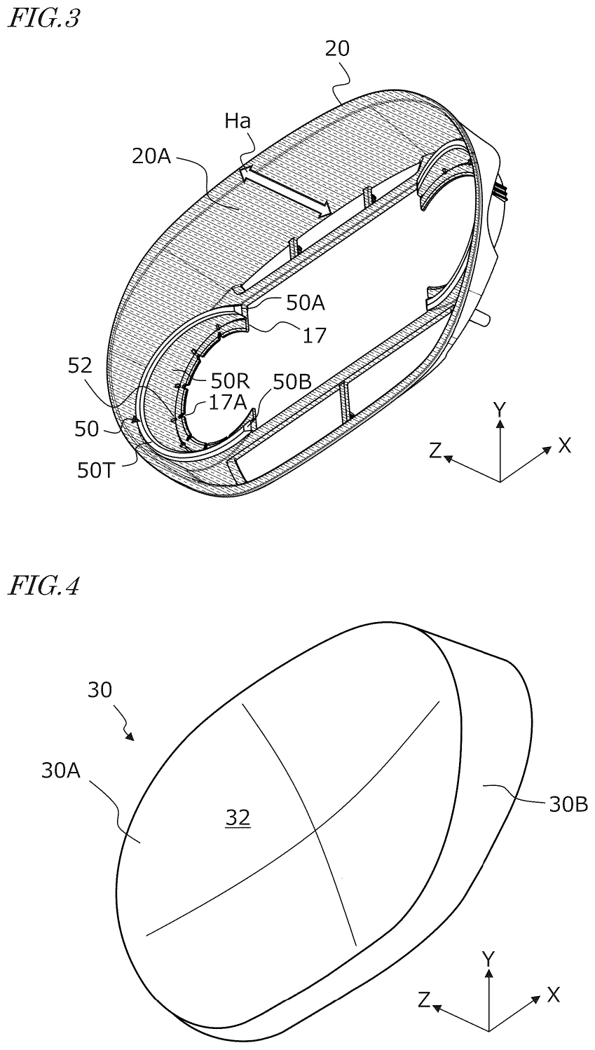

An overall configuration of the meter panel unit 100 will be described below with reference to FIGS. 2, 3, and 4. FIG. 2 is a front view illustrating an example arrangement of main components of the meter panel unit 100 of this example embodiment. FIG. 3 is a perspective view illustrating an example configuration of a wall surface described below of the meter panel unit 100. FIG. 4 is a front view illustrating an example configuration of a transparent cover described below of the meter panel unit 100. These drawings illustrate an X-axis, a Y-axis, and a Z-axis that are orthogonal to one another for reference (right-handed coordinate system). In the present description, the positive direction of the Y axis is also referred to as “upward,” and the negative direction thereof is also referred to as “downward.” The positive direction of the X axis is also referred to as “rightward,” and the negative direction thereof is also referred to as “leftward.” The positive direction of the Z axis is also referred to as “forward,” and the negative direction thereof is also referred to as “backward.”

As illustrated in FIG. 2, the meter panel unit 100 includes a meter portion 10 including a first analog meter 11, a second analog meter 12, and a display 13 between the first and second analog meters 11 and 12. In the present description, a portion of the meter portion 10 of FIG. 2 that displays information is also referred to as a display surface side of the meter portion 10.

The first analog meter 11 includes a pointer 2A, and the second analog meter 12 includes pointers 2B and 2C. The pointer 2A is supported in a manner that allows the pointer 2A to revolve around the axis of rotation positioned near the center of the first analog meter 11. The pointer 2A indicates the engine speed by the direction in which the tip of the pointer 2A is oriented, for example. The pointers 2B and 2C are supported in a manner that allows the pointers 2B and 2C to revolve around the respective axes of rotation located at different positions of the second analog meter 12. The pointer 2B indicates the remaining amount of fuel by the direction in which the tip of the pointer 2B is oriented. The pointer 2C indicates the temperature (water temperature) of engine-cooling water by the direction in which the tip of the pointer 2C is oriented, for example. The pointers 2A, 2B, and 2C are driven by a driver included in the meter portion 10. The driver receives an electrical signal indicating a sensor output such as the engine speed, the remaining amount of fuel, or the water temperature, and converts the electrical signal into mechanical movements to change the orientations of the pointers 2A, 2B, and 2C. The driver for each pointer 2A, 2B, 2C includes an actuator such as a stepping motor.

The display 13 is a digital meter rather than an analog meter. The display 13 is, for example, an active matrix display, such as a liquid crystal display panel or organic light emitting diode (OLED). The display 13 has a large number of pixels two-dimensionally positioned in a display region, and provides display visible to the human eye by emitting light from the large number of pixels. In this example embodiment, each pixel of the display 13 includes R, G, and B subpixels, and therefore, the display 13 is capable of displaying color images. Unlike analog meters, the display 13 is capable of displaying numerals, letters, graphics, symbols, still images, or moving images having any appropriate sizes at any appropriate positions in the display region. Strictly speaking, numerals, letters, graphics, and symbols are a portion of images (still images or moving images) displayed in the display region by the display 13. The display 13 is also capable of apparently displaying an image similar to all or a portion of an analog meter including a pointer. In the case in which the display 13 displays an image of an “analog meter,” a “pointer” in the image can be turned in any appropriate direction as a portion of moving images, by changing images on a frame-by-frame basis. It should be noted that in the case in which the work vehicle is an electric vehicle that is driven by a battery, the display of the engine speed, the remaining amount of fuel, and the water temperature may, for example, be replaced by the display of the power of a motor, the state of charge of the battery, and the temperature of the battery, respectively.

The “analog meter” displayed by a display device such as the display 13 is different from the first analog meter 11 and the second analog meter 12 in that the former is two-dimensional and the latter is three-dimensional. In addition, whereas the shape, color, and size of the pointer and scales of the former analog meter are changeable, it is difficult to change those of the latter. Furthermore, the visibility of the former depends on the contrast of an image, and therefore, is likely to decrease during the daytime, when external light is strong, whereas such a problem with the latter is relatively small. With the above in mind, in this example embodiment, a portion of information displayed in the meter portion 10, particularly information having high importance and requiring high visibility, is displayed using an analog meter having a three-dimensional structure.

An external shape of the meter portion 10 when the meter portion 10 is viewed from the front of the display surface side is a closed loop similar to an ellipse. The external shape of the meter portion 10 is not limited to such an example. The external shape of the meter portion 10 when the meter portion 10 is viewed from the front may have generally a rectangular shape, or a shape that is a combination of a straight line and a curved line. It should be noted that if the size in the horizontal direction (X-axis direction) of the meter portion 10 is increased, both end portions of the meter portion 10 are hidden by the spokes 222A and 222B as illustrated in FIG. 1B, and therefore, the visibility from the operator is likely to decrease. As described below, in the meter panel unit 100 of this example embodiment, such a decrease in visibility can be reduced while information displayed by the meter portion 10 can be clearly presented to the operator.

The meter panel unit 100 further includes a wall surface 20 fixed to the display surface side of the meter portion 10, and a transparent cover 30 opposite the display surface of the meter portion 10. Example configurations of the wall surface 20 and the transparent cover 30 will be described below.

The wall surface 20 surrounds the first analog meter 11, the display 13, and the second analog meter 12 entirely along the peripheral edge of the meter portion 10. The wall surface 20 may, for example, be formed of a plastic (synthetic resin). The wall surface 20 protrudes vertically (the positive direction of the Z axis) from the display surface of the meter portion 10. The wall surface 20 does not necessarily need to be perpendicular to the display surface of the meter portion 10, and may be tilted from the Z axis. In the present disclosure, the distance between the display surface of the meter portion 10 and an end on the front side of the wall surface 20 is referred to as a “height” of the wall surface 20. As described below, in this example embodiment, the height of the wall surface 20 is not uniform along the peripheral edge of the meter portion 10, and may vary depending on the position on the peripheral edge.

In this example embodiment, a rough shape of the wall surface 20 when the wall surface 20 is viewed from the front of the meter portion 10 is a closed loop such as an ellipse. In such a region surrounded by the wall surface 20, or the inside of the wall surface 20, a single, continuous, three-dimensional space surrounded by the inner wall surface of the wall surface 20 is formed.

As illustrated in FIG. 3, the wall surface 20 includes a portion having a relatively great height and a portion having a relatively small height. The portion having a relatively great height of the wall surface 20 includes a visor region 20A. At least the visor region 20A of the wall surface 20 has light-blocking properties. The visor region 20A is positioned at a position above the display 13 with the meter panel unit 100 attached to the work vehicle. The visor region 20A of the wall surface 20 serves as eaves to reduce a decrease in the display visibility of the meter portion 10 caused due to external light such as sunlight shining on the display 13 or the like. A height (greatest height) Ha of the visor region 20A is at least about 20 mm, preferably at least about 35 mm, and more preferably at least about 40 mm, for example. When the wall surface 20 is viewed from the direction of the normal to the meter portion 10, the visor region 20A extends to the left and right across a range wider than the display 13, surrounding an upper half portion of each of the first analog meter 11 and the second analog meter 12. The height of the visor region 20A is greatest above the display 13 and becomes smaller toward the left and right ends of the display 13.

The height of the wall surface 20 is relatively small at a position close to the lower end of the meter portion 10. The smallest height of the wall surface 20 may, for example, be at most 5 mm, or may be 0 mm.

FIG. 3 also illustrates, in addition to the wall surface 20, other structural components that are integral with the wall surface 20. As described above, the wall surface 20 may be made of a plastic, and therefore, the wall surface 20 and other structural components can be produced simultaneously by a resin molding technique. Structural components other than the wall surface 20 of FIG. 3 are described below.

As illustrated in FIG. 4, the transparent cover 30 includes a front surface section 30A including a concave surface 32, and a side surface section 30B extending from the peripheral edge of the front surface section 30A along the outer side of the wall surface 20. The side surface section 30B of the transparent cover 30 can cover the outer side of the wall surface 20 along all the periphery thereof. The transparent cover 30 may, for example, be made of a colorless, transparent plastic (e.g., acrylic resin), or glass. In this example embodiment, the front surface section 30A and the side surface section 30B of the transparent cover 30 are integrally formed together.

When the transparent cover 30 is viewed from the direction of the normal to the meter portion 10 with the meter panel unit 100 attached to the work vehicle, the front surface section 30A of the transparent cover 30 is preferably tilted forward toward the operator. In the case in which the front surface section 30A is tilted forward, when the operator sees the meter portion 10 through the transparent cover 30, the operator's face and the background behind the operator are less likely to be reflected on the transparent cover 30.

Because the front surface section 30A of the transparent cover 30 has the concave surface 32, when the operator sees the meter portion 10 through the transparent cover 30, enlarged images of the operator and the background reflected by the transparent cover 30 are seen by the operator. This is because concave surface reflection occurs due to the front surface section 30A of the transparent cover 30. When information displayed by the meter portion 10 is represented by relatively small numerals, letters, graphics, or the like, the visibility of displayed information decreases as the spatial frequency of reflections on the transparent cover 30 decreases. According to this example embodiment, such a decrease in visibility can be reduced.

The curvature ρ of the concave surface 32 of the transparent cover 30 is preferably uniform in each of the horizontal direction (the X-axis direction or the left-right direction) and the vertical direction (the Y-axis direction or the top-bottom direction). The curvature ρ determines the factor of magnification of a viewed image. As the curvature ρ is more uniform irrespective of direction, the concave surface 32 is closer to a portion of a sphere, and therefore, an enlarged image having a natural ratio is seen. It should be noted that the front surface section 30A does not necessarily need to have a concave surface. For example, in the case in which the front surface section 30A of the transparent cover 30 is covered with anti-reflection film, it is no longer to address reflections, and therefore, the front surface section 30A may be a flat surface or a convex surface.

The side surface section 30B of the transparent cover 30 extends along the outer side of the wall surface 20. Therefore, the side surface section 30B has a height corresponding to the height of the wall surface 20. For example, the height of a portion of the side surface section 30B of the transparent cover 30 that covers the visor region 20A of the wall surface 20 is greater than that of the other portion. A space delimited by the front surface section 30A and the side surface section 30B of the transparent cover 30 is referred to as an “inner space” of the transparent cover 30. The shape and size of the inner space of the transparent cover 30 are great enough to accommodate substantially the entirety of the wall surface 20. As described above, a single, continuous, three-dimensional space surrounded by the inner wall surface of the wall surface 20 is formed inside the wall surface 20. A front side of this three-dimensional space is delimited and blocked by the transparent cover 30. The outer side of the wall surface 20 may be in contact with the inner side of the side surface section 30B of the transparent cover 30, or a space may be provided therebetween.

It should be noted that condensation of water vapor existing in the “inner space” is likely to occur to fog the transparent cover 30. In order to prevent such fogging, the surface of the transparent cover 30 may be coated with an antifogging agent. Alternatively, an antifogging effect can be obtained by providing a small opening in a portion of the meter portion 10 so that the inner space is in fluid communication with the outside. It should be noted that the transparent cover 30 does not need to be entirely transparent. For example, the side surface section 30B does not need to be transparent.

Next, an indicator region of the meter portion 10 will be described with reference to FIG. 5. In the example of FIG. 5, the meter portion 10 has an indicator region 14T provided above the display 13, and indicator regions 14L and 14R provided below the display 13. Various indicators are provided in each of the indicator regions 14T, 14L, and 14R. Each indicator presents predetermined information such as warning when a light emitting device such as a light emitting diode (LED) behind the indicator is on.

The indicator regions 14T, 14L, and 14R are each provided at a position where the indicator regions 14T, 14L, and 14R can be seen through between the spoke 222A and the spoke 222B as illustrated in FIG. 1B. However, because the horn cover 221 is provided at the center of the steering wheel 220, the horn cover 221 may prevent a central portion of a region positioned directly below the display 13 from being seen. More specifically, the rough outer shape of the horn cover 221 of the steering wheel 220 when the meter portion 10 is viewed by the operator from the front is typically circular or close to circular. Therefore, in the vicinity of the lower end of the meter portion 10, when a portion of the meter portion 10 closer to the center of the lower end is viewed from the operator, that portion is more likely to be hidden by the horn cover 221. In this example embodiment, the two separate left and right indicator regions 14L and 14R are positioned below the display 13, and therefore, the horn cover 221 of the steering wheel 220 is less likely to decrease the visibility. In addition, in this example embodiment, an empty region 15 is provided which extends across the boundary between the indicator regions 14L and 14R. The empty region 15 includes empty regions 15L and 15R. In the left indicator region 14L, indicators are relatively concentrated on a left side, and the first empty region 15L is provided at a position close to the right end. In contrast to this, in the right indicator region 14R, indicators are relatively concentrated on a right side, and the second empty region 15R is provided at a position close to the left end. The first empty region 15L and the second empty region 15R are more likely to be hidden by the horn cover 221 of the steering wheel 220 and therefore is less likely to be seen if the horn cover 221 is large. However, in this example embodiment, indicators are not provided in the empty region 15, and therefore, overlooking of indicators can be reduced.

An illuminance sensor 16 may be provided in at least one of the first empty region 15L and the second empty region 15R. The present inventors' study demonstrated that if the illuminance of the meter portion 10 is adjusted (adjustment of display luminance) by unitizing the illuminance sensor 16 provided in the empty region 15L, 15R, the illuminance can be accurately detected without the influence of the brightness of an image displayed on the display 13, resulting in an appropriate display luminance. The illuminance sensor 16 positioned below the display 13 is in the shade of the visor region 20A of the wall surface 20, and therefore, is less likely to be directly illuminated by sunlight, and therefore, is capable of accurately detecting the illuminance, on which the lightness of an environment around the operator is appropriately reflected. In addition, if the illuminance sensor 16, which does not need to be seen, is positioned in a region of the meter portion 10 that is not easily seen from the operator due to the horn cover 221's occlusion, instead of indicators, resulting in a contribution to efficient utilization of an empty space in the meter portion 10. If a no-light-emitting region (e.g., the empty regions 15L and 15R) having a width of at least about 5 mm, for example, is provided on either side of the illuminance sensor 16, the influence of light emitted from indicators on the illuminance detection performed by the illuminance sensor 16 can be reduced.

In this example embodiment, the brightness of a light emitting region of an arc-shaped indicator described below can be changed, depending on the output from the illuminance sensor 16. The brightness of the display 13 can also be changed, depending on the output from the illuminance sensor 16.

Seeing the indicator region 14T, which is positioned above the display 13, is less likely to be obstructed by the spokes 222A, 222B, and 222C of the steering wheel 220, compared to the other indicator regions 14L and 14R. Therefore, it is preferable that indicators for indicating particularly important information (information having a higher warning level) (e.g., indicators for indicating the on/off state of the illumination device, turn signals, and warnings to the operator) be selected from a large number of indicators and positioned in the indicator region 14T. The “warning level” of information displayed by an indicator may, for example, be specified in the manual of the work vehicle. For example, information such as the abnormality or failure of the engine and the on/off state of the headlamp has a higher warning level.

As described below, a controller may be configured or programmed to perform automatic switching or luminance adjustment of the headlamp and work lamp of the work vehicle based on the illuminance detected by the illuminance sensor 16.

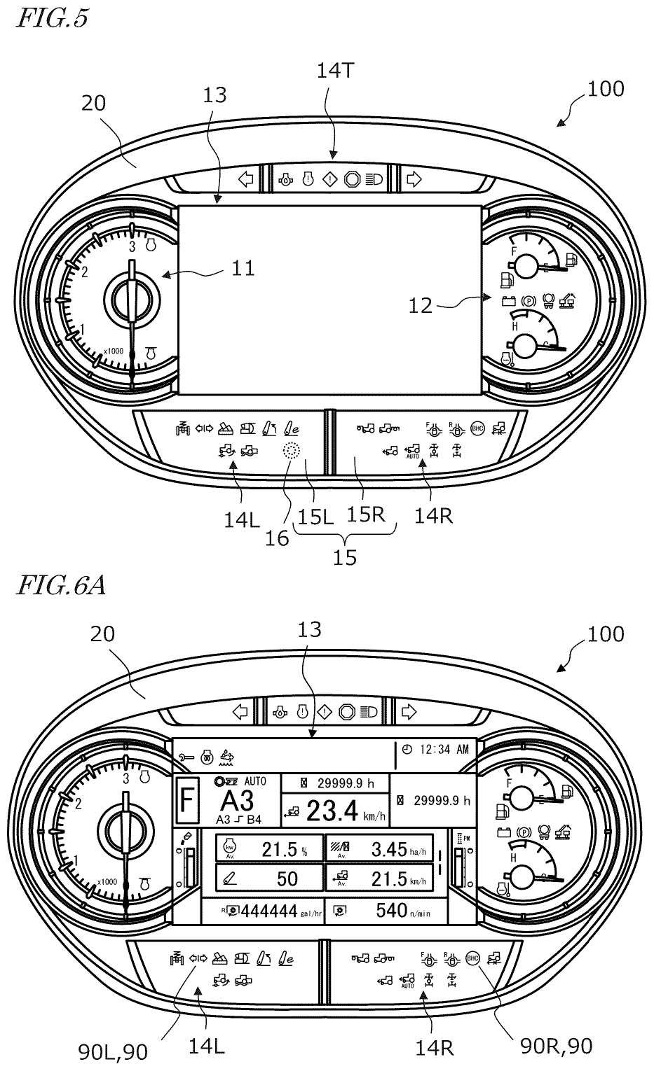

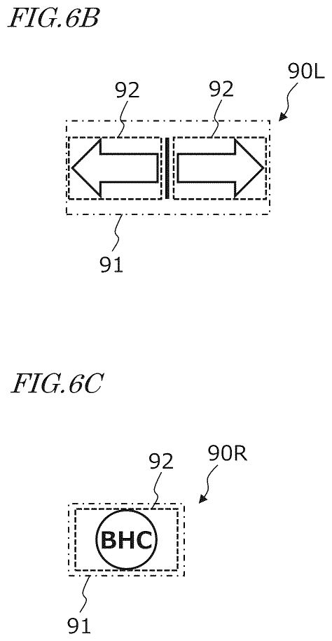

Next, an example display of the display 13 will be described with reference to FIG. 6A. In the example of FIG. 6A, the display region of the display 13 is divided into several regions. In each region, an “image” showing information such as the gear ratio, travel speed, function performance display, or hour meter is displayed. The images include various kinds of information represented by letters, numerals, symbols, and the like. Various kinds of digital data may be indicated by different colors in order to increase the visibility. In particular, when the operator's attention should be attracted, display may be performed in which at least one of the positions, sizes, or colors of letters, numerals, or symbols are changed and emphasized. When such emphasized display is performed, sound or speech may be emitted from an audio device such as a loudspeaker.

It should be noted that in this example embodiment, as illustrated in FIG. 6B or 6C, each indicator 90 of FIG. 6A includes a light transmission region 91 having a shape specifying each characteristic graphic (including an icon and/or letters), and a light emitting device 92 positioned behind the light transmission region 91. The indicator 90 may be turned on/off by the light emitting device 92 behind the indicator 90 being turned on/off. One or two light emitting devices 92 are positioned behind each indicator 90. For example, as illustrated in FIG. 6B, in the indicator region 14L, indicators to each of which two light emitting devices 92 are assigned may be positioned, and as illustrated in FIG. 6C, in the indicator region 14R, indicators to each of which a single light emitting device 92 is assigned may be positioned. In this example, the indicator region 14L includes a relatively large indicator 90L, and the indicator region 14R includes a relatively small indicator 90R. In this case, two light emitting devices 92 may be positioned behind the relatively large indicator 90L, and a single light emitting device 92 may be positioned behind the relatively small indicator 90R. Such an arrangement is achieved even in the case in which the intervals at which the light emitting devices are positioned are invariable. To this end, a light transmission region for a relatively large indicator is formed, extending across two adjacent light emitting devices, and a light transmission region for a relatively small indicator is formed, extending across a single light emitting device. For indicators, graphics (icons) or letters having different sizes can be selectively used, and therefore, the visibility can be increased by enlarging an indicator having a higher warning level. In addition, if light emitting devices are equally spaced irrespective of the sizes of indicators, a base board on which light emitting devices are mounted (light emitting device base board) can be shared and utilized by various work vehicles.

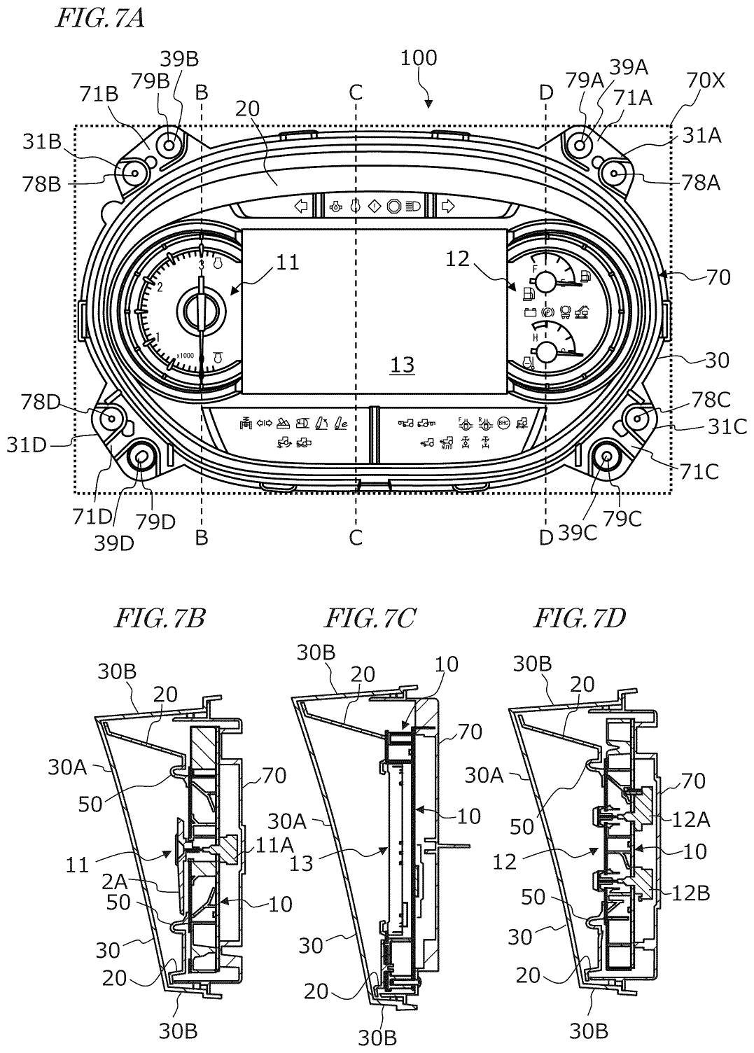

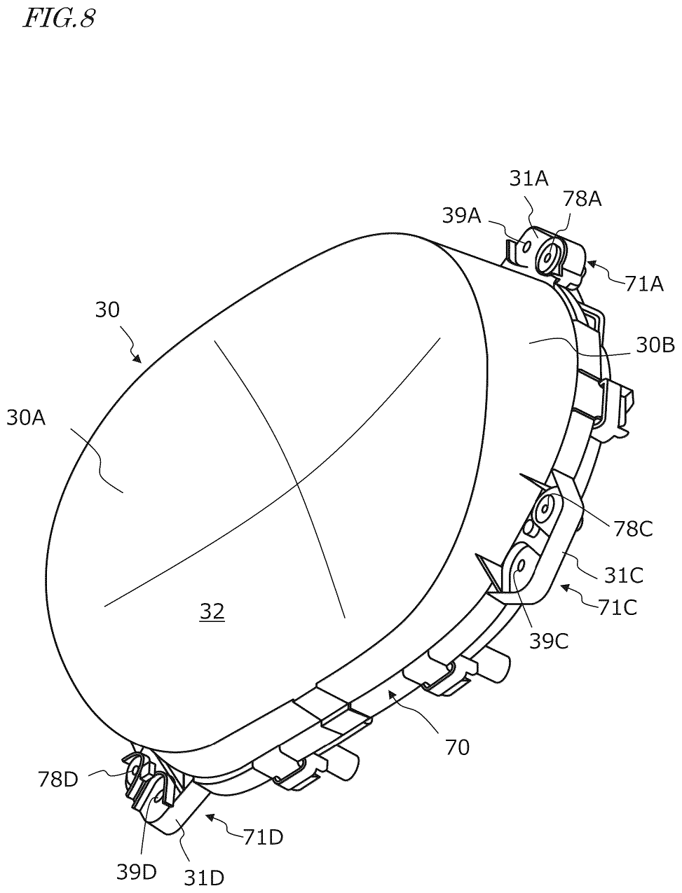

Next, an example configuration of the meter panel unit 100 will be described in more detail with reference to FIGS. 7A, 7B, 7C, and 7D. FIG. 7A is a front view illustrating a detailed configuration of the meter panel unit 100 of this example embodiment. FIGS. 7B, 7C, and 7D are cross-sectional views taken along line B-B, C-C, and D-D, respectively, of FIG. 7A.

As illustrated in FIGS. 7B to 7D, the transparent cover 30 covers the wall surface 20. The transparent cover 30, more specifically, the front surface section 30A of the transparent cover 30, is tilted forward toward the operator as viewed from the direction of the normal to the meter portion 10. As described above with reference to FIG. 3, the visor region 20A of the wall surface 20 serves as eaves.

The side surface section 30B of the transparent cover 30 is fixed to the meter portion 10. More specifically, in this example embodiment, the meter portion 10 is fixed to a rear cover 70 provided on the back surface side of the meter portion 10, and the transparent cover 30 is fixed to the rear cover 70. In the illustrated example, the rear cover 70 includes movable parts 11A, 12A, and 12B of the pointer 2A, 2B, and 2C of the meter portion 10. The movable parts 11A, 12A, and 12B are electrically connected to various sensors or an electrical control unit (ECU) included in the work vehicle. Such electrical connection is established through a wiring cable that is connected to an electronic component included in the meter panel unit 100. In the figures, the wiring cable is not illustrated.

As illustrated in FIG. 7A, the rear cover 70 of the meter panel unit 100 includes, for example, four fixing sections 71A, 71B, 71C, and 71D to fix the transparent cover 30 to the rear cover 70. The fixing sections 71A, 71B, 71C, and 71D include bolt holes 79A, 79B, 79C, and 79D, respectively.

The transparent cover 30 includes fixing section covers 31A, 31B, 31C, and 31D at positions corresponding to the fixing sections 71A, 71B, 71C, and 71D. FIG. 8 is a perspective view illustrating a state in which the transparent cover 30 is fixed to the rear cover 70 so as to cover the wall surface 20 and the meter portion 10. In this state, the fixing section covers 31A, 31B, 31C, 31D of the transparent cover 30 are opposite the fixing sections 71A, 71B, 71C, and 71D, respectively, and cover the upper and side surfaces of the fixing sections 71A, 71B, 71C, and 71D, respectively. It should be noted that FIG. 8 does not illustrate the fixing section 71B or the fixing section cover 31B.

The fixing section covers 31A, 31B, 31C, and 31D of the transparent cover 30 include bolt holes 39A, 39B, 39C, and 39D that are opposite the bolt holes 79A, 79B, 79C, and 79D of the fixing sections 71A, 71B, 71C, and 71D, respectively. Each pair of opposite bolt holes is fastened by a bolt, so that the transparent cover 30 is fixed to the meter portion 10.

It should be noted that not all the bolt holes 79A, 79B, 79C, and 79D need to have the same size and shape. In the example of FIG. 7A, the bolt hole 79D has a size and shape different from those of the other bolt holes 79A, 79B, and 79C. Specifically, although the bolt hole 79D has an elliptical shape as viewed from the front, the other bolt holes 79A, 79B, and 79C have a circular shape. Although the bolt hole 79D has a size larger than that of a bolt used for linkage in a predetermined direction, the other bolt holes 79A, 79B, 79C are adapted to the size of a bolt. Because the bolt hole 79D thus has a size larger than that of a bolt, dimension deviations (dimension errors) can be accommodated when the transparent cover 30 is attached to the rear cover 70.

As illustrated in FIG. 7A, the meter portion 10, which includes the fixing sections 71A, 71B, 71C, and 71D, is entirely contained in a rectangular region 70X. The rectangular region 70X corresponds to a circumscribed rectangle that touches the outer shape of the meter panel unit 100. The fixing sections 71A, 71B, 71C, and 71D protrude from the body of the rear cover 70 toward the four respective corners of the rectangular region 70. In the case in which the housing of the meter portion 10 is produced by resin molding, as the size of the rectangular region 70X for containing the entire meter portion 10 increases, the manufacturing cost of the mold increases. In this example embodiment, the positions of the fixing sections 71A, 71B, 71C, and 71D are close to the four corners of the rectangular region 70X, and therefore, the manufacturing cost of the mold involved in the resin molding can be reduced.

It should be noted that the fixing sections 71A, 71B, 71C, and 71D have fastening holes 78A, 78B, 78C, and 78D, respectively, for a decorative ring. The decorative ring is described below.

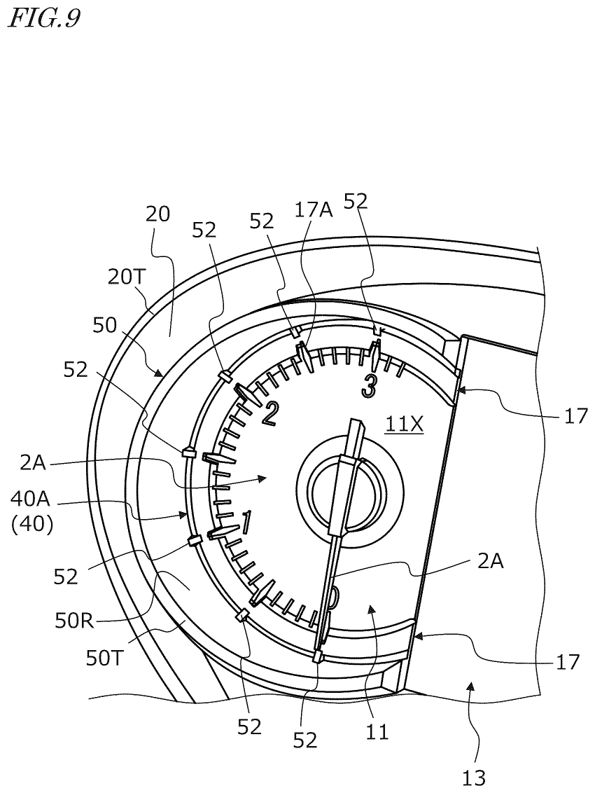

Next, an arc-shaped indicator (C-shaped communication ring) and a facing plate will be described with reference to FIGS. 9 to 12.

In this example embodiment, the meter panel unit 100 includes a first arc-shaped indicator (communication ring) 40A positioned around a sweep range 11X of the pointer 2A, and a second arc-shaped indicator 40B positioned around sweep ranges of the pointers 2B and 2C. In the present disclosure, the term “arc” means a portion of a circle (circumference). The circle is not limited to a “perfect circle,” and may include a portion whose curvature is gradually or locally changed like a portion of an ellipse.

The structure of the first arc-shaped indicator 40A and the structure of the second arc-shaped indicator 40B are symmetrical about a vertical line, and therefore, are collectively referred to as arc-shaped indicators 40. The arc-shaped indicators 40 will be described below using the first arc-shaped indicator (communication ring) 40A as an example, for the sake of simplicity.

As illustrated in FIG. 9, the meter panel unit 100 of this example embodiment includes a facing plate 50 positioned outward of the arc-shaped indicator 40. The facing plate 50 is formed of the same material (plastic) as that for the wall surface 20. As illustrated in FIG. 3, the facing plate 50 is integrally formed with the wall surface 20. The facing plate 50 is in the shape of roughly an arc as viewed from the front. A height of an upper end 50T of the facing plate 50 varies continuously from an end 50A on the upper side to an end 50B on the lower side, and is greatest at a middle position. The facing plate 50 is a curved wall rising from the meter portion 10. A height of the visor region 20A of the wall surface 20 from the meter portion 10 is greater than a height of the facing plate 50 from the meter portion 10. In other words, the greatest height of the visor region 20A from the meter portion 10 is greater than the greatest height of the facing plate 50 from the meter portion 10.

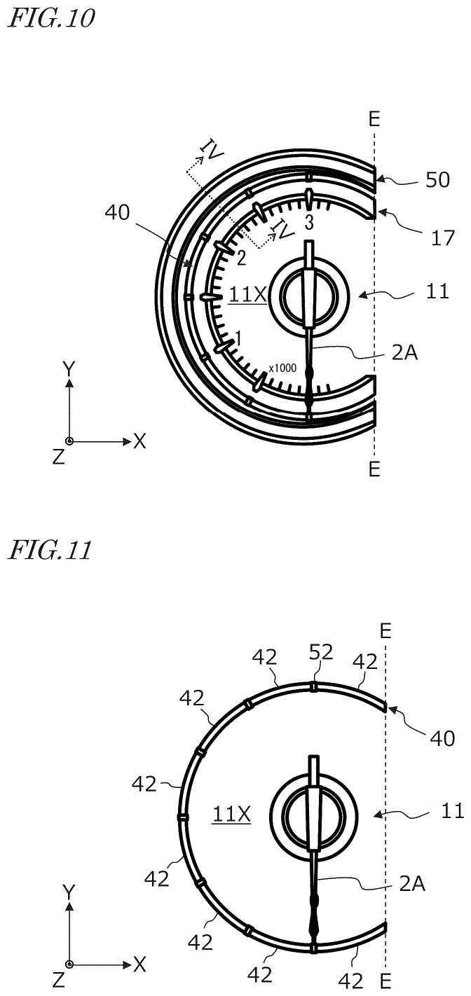

FIG. 10 is a front view illustrating a positional relationship between the first analog meter 11, the arc-shaped indicator 40, and the facing plate 50. FIG. 11 is a front view mainly illustrating an example configuration of the arc-shaped indicator 40. None of the first analog meter 11, the arc-shaped indicator 40, and the facing plate 50 extends rightward (the positive direction of the X axis) beyond a dashed line E-E of FIG. 10. The display 13 is positioned rightward (in the positive direction of the X axis) of the dashed line E-E.

With such a configuration, while the length of the pointer 2A, or the radius of the first analog meter 11, is increased, an increase in the size in the horizontal direction (X-axis direction) of the first analog meter 11 can be reduced. This also holds true for the second analog meter 12. It should be noted that as illustrated in FIG. 1B, when the size in the horizontal direction of the meter portion 10 is increased, the spokes 222A and 222B of the steering wheel 220 are more likely to obstruct seeing of the first and second analog meters 11 and 12. Therefore, it is not preferable to increase the size in the horizontal direction of the meter portion 10. In this example embodiment, the analog meter is contained inside a shape surrounded by the dashed line E-E and an arc rather than a circle. Therefore, even for the meter portion 10, which has a limited size in the horizontal direction, the size in the horizontal direction (X-axis direction) of the display 13 can be increased while the visibility of the first and second analog meters 11 and 12 is increased. In addition, because the first and second analog meters 11 and 12 and the display 13 are separated from each other by a straight line, the display area for analog information and the display area for digital information can be clearly separated from each other, and therefore, the visibility of both analog information and digital information can be improved.

In order to obtain the above effect, it is preferable that the central angle of the “arc” of the arc-shaped indicator 40 (40A), which is positioned, surrounding the first analog meter 11, be greater than about 180° and smaller than about 270°, for example. If the central angle of the “arc” is at most about 180°, the visibility of the first analog meter 11 decreases. If the central angle of the “arc” is at least about 270°, the effect of reducing the size in the horizontal direction (X-axis direction) of the first analog meter 11 is not sufficient. This also holds true for the arc-shaped indicator 40 (40B) surrounding the second analog meter 12. In terms of design properties, it is preferable that the left and right arc-shaped indicators 40A and 40B be positioned symmetrically about a vertical line passing through the center of the display 13.

The arc-shaped indicator 40 has at least one light emitting region 42 between the sweep range 11X of the pointer 2A and the facing plate 50. In the example of FIG. 11, a plurality of light emitting regions 42 are provided. In this example, each light emitting region 42 has a fine curved shape extending along an arc. The plurality of light emitting regions 42 are positioned in a sequence of arcs to form the arc-shaped indicator 40. In the case in which the number of light emitting regions 42 is one, a single light emitting region 42 has an arc shape.

In the example illustrated in the figure, the first analog meter 11 has an arc-shaped scale 17 between the arc-shaped indicator 40 and the sweep range 11X of the pointer 2A. The scale 17 has a three-dimensional shape protruding from the display surface (raised scale). The scale 17 is formed of a plastic integrally with the wall surface 20 and the facing plate 50. It should be noted that the scale 17 does not necessarily need to have a three-dimensional shape. The scale 17 desirably has a three-dimensional shape in terms of higher visibility.

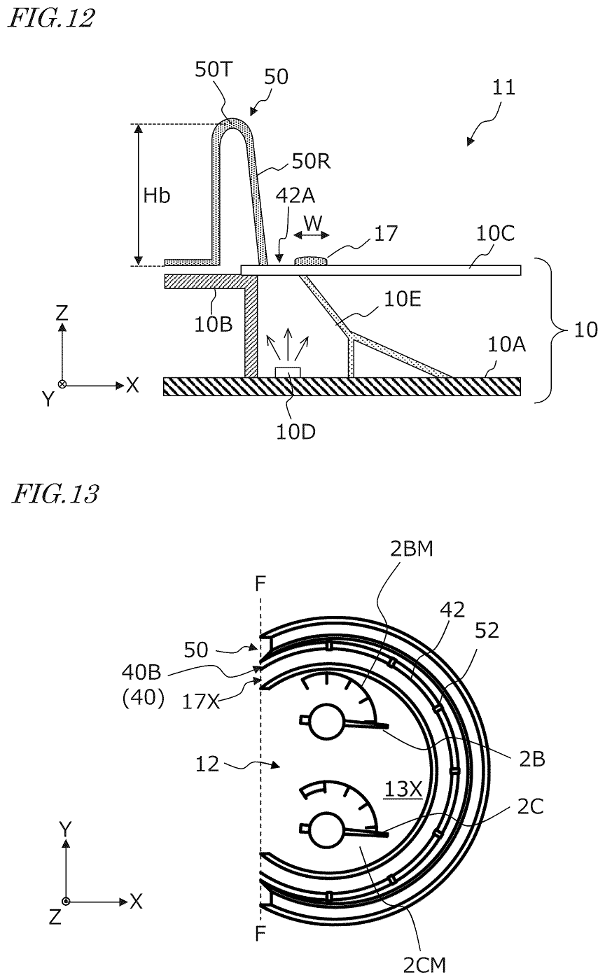

Although the plurality of light emitting regions 42 included in the arc-shaped indicator 40 may each include a light emitting element (e.g., an LED or OLED), in this example embodiment, the plurality of light emitting regions 42 are configured with a plurality of light transmission regions provided on the display surface of the meter portion 10 (i.e., the surface on the front side of the housing of the meter portion 10) and at least one light emitting device positioned behind the plurality of light transmission regions. This feature will be described below with reference to FIG. 12. FIG. 12 is a cross-sectional view taken along line IV-IV of FIG. 10.

In this example embodiment, the body of the meter portion 10 includes a base board 10A and a support section 10B. In the region of the first analog meter 11, an opening is provided on the front side of the support section 10B. The opening is closed by a meter dial 10C. The meter dial 10C is formed of a plastic having light transmission properties (e.g., polycarbonate), and has, at a surface thereof, a printed layer having letters, numerals, and patterns drawn in any color, white, or black. An end portion of the facing plate 50 and the raised scale 17 are positioned near an end portion of the meter dial 10C. As illustrated in the cross-sectional view of FIG. 12, there is a space between the facing plate 50 and the raised scale 17, and the space defines the light transmission region 42A. A portion of the meter dial 10C that serves as the light transmission region 42A is configured to transmit light. On the back side (the side in the negative direction of the Z axis) of the light transmission region 42A, at least one light emitting device 10D is mounted on the base board 10A. In addition to the light emitting device 10D, other electronic components, and electronic components such as electronic circuits (including integrated circuit devices), may be mounted on the base board 10A. These electronic components may be electrically connected through wiring on the base board 10A.

The light transmission region 42A, which transmits light emitted from the light emitting device 10D, defines and functions as the light emitting region 42 of the arc-shaped indicator 40. The shape and size of each light emitting region 42 of the arc-shaped indicator 40 are determined by the shape and size of the corresponding light transmission region 42A. The number of light emitting devices 10D provided below each of the plurality of light transmission region 42A or light emitting regions 42 is not limited to one, and may be plural. Alternatively, the plurality of light transmission regions 42A may be provided so as to transmit light emitted from a single light emitting device 10D.

The plurality of light emitting devices 10D may include a plurality of LEDs that emit different colors. In the example of FIG. 12, a portion of light emitted from the light emitting device 10D may be directly transmitted through the light transmission region 42A, and the other portion of the light may be reflected by an optical structure 10E or the like. The optical structure 10E may be a diffusion plate, reflection plate, light guide plate, or multilayer structural component including these plates.

In this example embodiment, the plurality of light emitting devices 10D include an LED that emits red light, an LED that emits green light, and an LED that emits blue light. By causing these LEDs to selectively emit light, the arc-shaped indicator 40 can exhibit the function of notifying the operator of information using light having various colors. For example, all of the light emitting regions 42 of FIG. 11 can selectively emit red light, green light, and blue light. Alternatively, a light emitting device 10D may be assigned to each of the plurality of light emitting regions 42, and the plurality of light emitting devices 10D may be caused to emit light separately, so that light beams can be sequentially emitted from the plurality of light emitting regions 42.

In this example embodiment, the facing plate 50 is positioned outward of the arc-shaped indicator 40, and the inner surface of the facing plate 50 serves as a reflective surface 50R. The reflective surface 50R can reflect light emitted from the plurality of light emitting regions 42 toward the operator. The presence of the reflective surface 50R improves the visibility of the arc-shaped indicator 40. The reflective surface 50R does not need to cause specular reflection, and may be a rough surface as long as the reflective surface 50R can cause diffuse reflection.

A height Hb of the facing plate 50 from the meter portion 10 (see FIG. 12) is highest at a lateral position with respect to a middle portion 40C of the arc-shaped indicator 40. As illustrated in FIG. 3, the height Hb becomes smaller toward both ends 50A and 50B of the facing plate 50 along the arc-shaped indicator 40. The greatest value of the height Hb is, for example, at least about 30 mm. If the facing plate 50 thus configured is provided close to and outward of the arc-shaped indicator 40 (e.g., a space of at most 5 mm interposed therebetween), the visibility of the arc-shaped indicator 40 from the operator's position can be increased, and external light entering surroundings of the plurality of light emitting regions 42 of the arc-shaped indicator 40 can be reduced. Although the entrance of external light may decrease the display contract of the arc-shaped indicator 40, not only the wall surface 20 but also the facing plate 50, which is provided closer thereto and has a great height, exhibit a light-blocking function. Such a double light-blocking function can reduce a decrease in the visibility of the arc-shaped indicator 40.

It should be noted that the reason why the facing plate 50, which has a great height, can be provided is that the size in the Z-axis direction of the three-dimensional space surrounded by the wall surface 20 is sufficiently large. In this example embodiment, in addition to the visor region 20A of the wall surface 20, the facing plate 50, which is provided on the left and right sides, has a great height. Therefore, the synergistic effect of both thereof effectively blocks external light from the surroundings, and therefore, the display of the display 13 and the left and right arc-shaped indicators 40 can be lightly seen by the operator.

Next, the raised scale 17 will be described. As illustrated in FIGS. 9 and 10, the raised scale 17 extends in the shape of an arc inside the arc-shaped indicator 40 to form generally a C-shape. As illustrated in FIGS. 3 and 9, the raised scale 17 includes a plurality of notches 17A positioned at predetermined intervals. The notch 17A is a portion of the raised scale 17 whose width W illustrated in FIG. 12 is locally reduced. The position of the notch 14A corresponds to the position of a scale that is to be indicated by the tip of the pointer 2A in the first analog meter 11. The presence of the three-dimensional notches 14A facilitates reading of scales by the operator.

As illustrated in FIG. 9, the facing plate 50 includes a plurality of protrusions 52 that protrude toward the sweep range 11X of the pointer 2A. The plurality of protrusions 52 are provided at the positions of the notches of the raised scale 17, or in other words, positions aligned with the scales. Therefore, the notch 14A of the raised scale 17 is recognized as a graphic integrated with the protrusion 52, resulting in an improvement in the visibility of the scale. The plurality of protrusions 52 each extend across between the plurality of light emitting regions 42 of the arc-shaped indicator 40. Therefore, the array of the plurality of light emitting regions 42 also corresponds to the array of the scales.

As can be seen from FIG. 3, the plurality of protrusions 52 serve as a bridge that connects the raised scale 17 to the facing plate 50. The facing plate 50 is connected to the wall surface 20. In this example embodiment, the wall surface 20, the facing plate 50, and the raised scale 17 are integrally formed of a resin. The plurality of protrusions 52, which extend from the facing plate 50, delimit a boundary portion of the plurality of light emitting regions 42 in the arc-shaped indicator 40. Even in the case in which the light transmission region 42A of FIG. 12 has a single continuous arc shape, if the plurality of protrusions 52 extends across the light transmission region 42A having such a shape, the plurality of light emitting regions 42 are formed.

In the case in which the wall surface 20, the facing plate 50, and the raised scale 17 are integrally formed by resin molding using a mold, the plurality of protrusions 52 are configured from a resin positioned in a resin passage in a mold for molding. By providing the plurality of protrusion 52 positioned at predetermined intervals, a softened resin easily flows during molding, and therefore, the wall surface 20, the facing plate 50, and the raised scale 17 can be easily integrally formed by resin molding.

Next, the second analog meter 12 and the second arc-shaped indicator 40B will be described with reference to FIG. 13. The second arc-shaped indicator 40B and the first arc-shaped indicator 40A are symmetrical about a vertical line, and have substantially the same configuration. A facing plate (right facing plate) 50 is provided outward of the second arc-shaped indicator 40B. The right facing plate 50 and the above facing plate (left facing plate) 50 are symmetrical about a vertical line.

Although an arc-shaped rib 14X corresponding to the raised scale 17 is provided inside the second arc-shaped indicator 40B, no notches are present in the arc-shaped rib 14X. Protrusions (bridges) 52 are equally spaced and between the arc-shaped rib 14X and the right facing plate 50 so as to delimit a plurality of light emitting regions 42 included in the second arc-shaped indicator 40B.

A sweep range 13X of the second pointer 2B and the third pointer 2C is provided in a range surrounded by the second arc-shaped indicator 40B. A rotational angle range 2BM of the second pointer 2B and a rotational angle range 2CM of the third pointer 2C have a similar or congruent outer shape. In the example of FIG. 3, the rotational angle range 2BM of the second pointer 2B and the rotational angle range 2CM of the third pointer 2C are vertically symmetric. The present disclosure is not limited to this. The rotational angle range 2BM and the rotational angle range 2CM may, for example, have such a shape and size that these ranges match each other when one of these ranges is translated in the vertical direction.

With such a configuration, scales can be intuitively read based on the movements of the second pointer 2B and the third pointer 2C, and are less likely to be erroneously read.

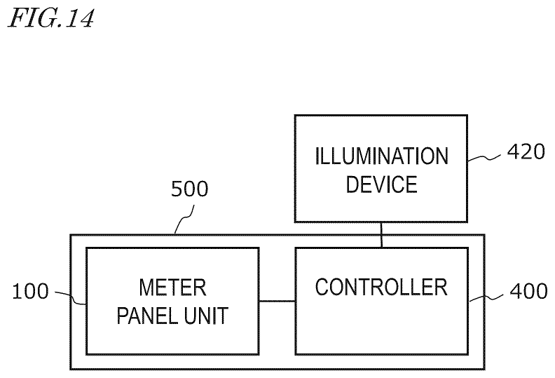

An information display system 500 according to an example embodiment of the present disclosure will be described below with reference to FIGS. 14 to 16. The information display system 500 includes the above meter panel unit 100, and a controller 400 configured or programmed to control the meter panel unit 100. The information display system 500 may be electrically connected to an illumination device 420 including the headlamp and work lamp of the work vehicle.

The controller 400 may be configured or programmed to cause the display 13 to display a warning message that prompts the operator to turn off the headlamp and/or work lamp according to the output from the illuminance sensor 16. For example, if the illuminance indicated by the output from the illuminance sensor 16 is at least a threshold, the controller 400 may be configured or programmed to cause the display 13 to display a warning message that prompts the operator to turn off the headlamp and/or work lamp. As a result, it is possible to effectively prevent the illumination device 420 from being unnecessarily in the on state, resulting in a reduction in power consumption.

A portion of the functions of the controller 400 may be executed by the meter panel unit 100. For example, all or a portion of the functions of the controller 400 may be executed by an integrated circuit device mounted on the base board 10A of the meter portion 10.

In the information display system 500 of this example embodiment, the controller 400 is configured or programmed to cause the display 13 to display various kinds of information after causing the arc-shaped indicator 40 to display information at vehicle startup. This allows information that the operator should know in the first place to be presented to the operator with higher priority at vehicle startup. Such information has information indicating a state (a state classified as abnormality in traveling or working) of the work vehicle. The controller 400 is also configured or programmed to change the color of emitted light according to contents of information. For example, the controller 400 may be configured or programmed to emit blue light from the arc-shaped indicator 40 when an abnormality does not arise during starting, and to emit red light indicating abnormality immediately after starting if a problem is expected to arise during traveling. Examples of a cause for a problem that will arise during traveling include an abnormal voltage of a battery, an abnormal pressure of an engine oil, abnormal heating of an engine, and an abnormality in a brake system. It should be noted that the color of the emitted light is not limited to blue or read, and may be green.

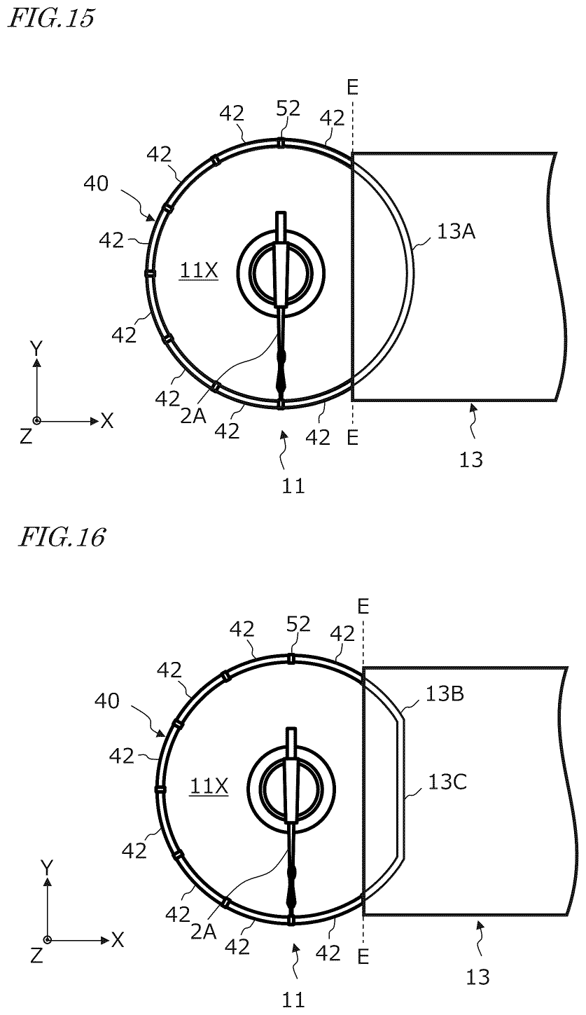

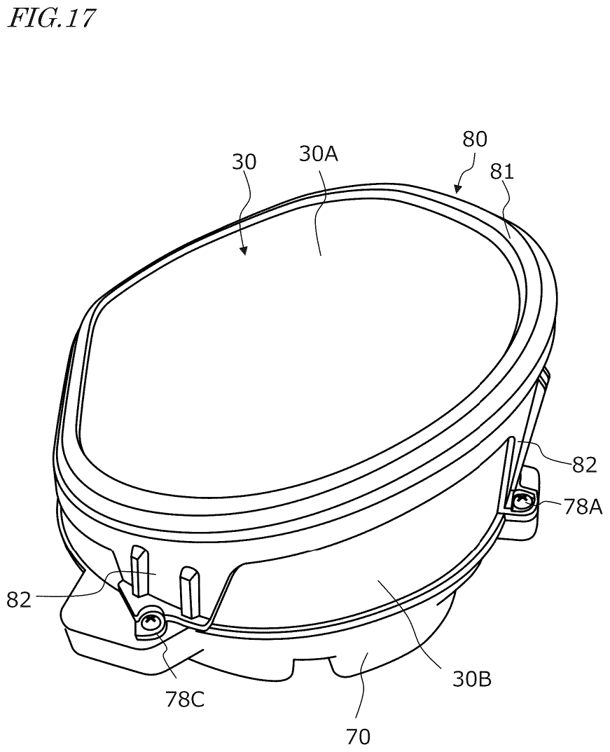

Furthermore, in this example embodiment, the controller 400 is configured or programmed to cause the display 13 to display a curved line-shaped image positioned on an extension line of the arc. FIG. 15 is a front view schematically illustrating an example in which an arc 13A having the same color as that of light emitted from the light emitting region 42 of the arc-shaped indicator 40 is displayed. In FIG. 15, as an example, an arc 13A having the same center as that of the arc of the arc-shaped indicator 40 is displayed. FIG. 16 is a front view schematically illustrating an example in which an arc 13B having the same color as that of light emitted from the light emitting region 42 of the arc-shaped indicator 40, and a second object 13C having another shape and having an arc having the same color, are displayed. In the example of FIG. 16, the second object 13C is a straight line portion. The controller 400 causes the display 13 to display the concentric arc 13B, and the straight line portion connected to the arc 13B. The straight line portion extends in parallel with a straight line forming the boundary between the first analog meter 11 and the display 13 (corresponding to a dashed line E-E of FIG. 16). By providing such display, a portion of the circle surrounding the first analog meter 11 that is cut away by the dashed line E-E is seen as a portion of the first analog meter 11 by the operator, and therefore, the operator can feel that the first analog meter 11 is large. In addition, an image that is displayed as if the image were a portion of the first analog meter 11 may be partially hidden by information such as numerals or letters displayed on the display 13. The display 13 may display more important information in a greater size or closer to the operator with higher priority.

The controller 400 can cause the display 13 to display various images, which are not limited to the examples of FIGS. 15 and 16, in association with light emitted from the light emitting region 42 of the arc-shaped indicator 40. The controller 400 can also cause the display 13 to display various images in synchronization with the flickering of the light emitting region 42 of the arc-shaped indicator 40. What is intended by the display of the arc-shaped indicator 40 to notify the operation can be more easily understood by the operator by emphasizing that display and the display of the display 13 or associating these displays with each other.

An example decorative ring in this example embodiment will be described with reference to FIGS. 7A, 8, and 17.

As described above, the fixing sections 71A, 71B, 71C, and 71D of the rear cover 70 include the fastening holes 78A, 78B, 78C, and 78D, respectively, for the decorative ring. The decorative ring is put on the transparent cover 30 when the transparent cover 30 is in a state illustrated in FIG. 8, and exhibits the function of enhancing the appearance in terms of design properties. FIG. 8 illustrates the three fastening holes 78A, 78C, and 78D.

FIG. 17 is a perspective view schematically illustrating a state in which a decorative ring 80 is fixed to the rear cover 70 with the decorative ring 80 put on the transparent cover 30. In this example, the decorative ring 80 may, for example, be formed of a resin material, and have a surface plated with a metal such as chromium. The decorative ring 80 may be formed of a metal. The decorative ring 80 includes a ring-shaped body 81, and a plurality of support sections 82 extending from the ring-shaped body to the fixing sections 71A, 71B, 71C, and 71D of the rear cover 70. The ring-shaped body 81 extends along an edge of the transparent cover 30, and does not obstruct seeing of the meter portion 10 through the transparent cover 30.

The appearance of the ring-shaped body 81 of the decorative ring 80 including the shape, color, material, pattern, and the like may be determined in various forms according to the operator's preference or the type or grade of the work vehicle. The decorative ring 80 is not necessarily an essential part for the meter panel unit 100. Therefore, the decorative ring 80 does not need to be fixed to the fixing sections 71A, 71B, 71C, and 71D of the rear cover 70. When the decorative ring 80 is not fixed to the fixing sections 71A, 71B, 71C, and 71D of the rear cover 70, no bolts or the like are inserted in the fastening holes 78A, 78B, 78C, and 78D for the decorative ring. If the meter panel unit 100 is equipped with the fastening holes 78A, 78B, 78C, and 78D in advance, the versatility of the meter panel unit 100 can be increased.

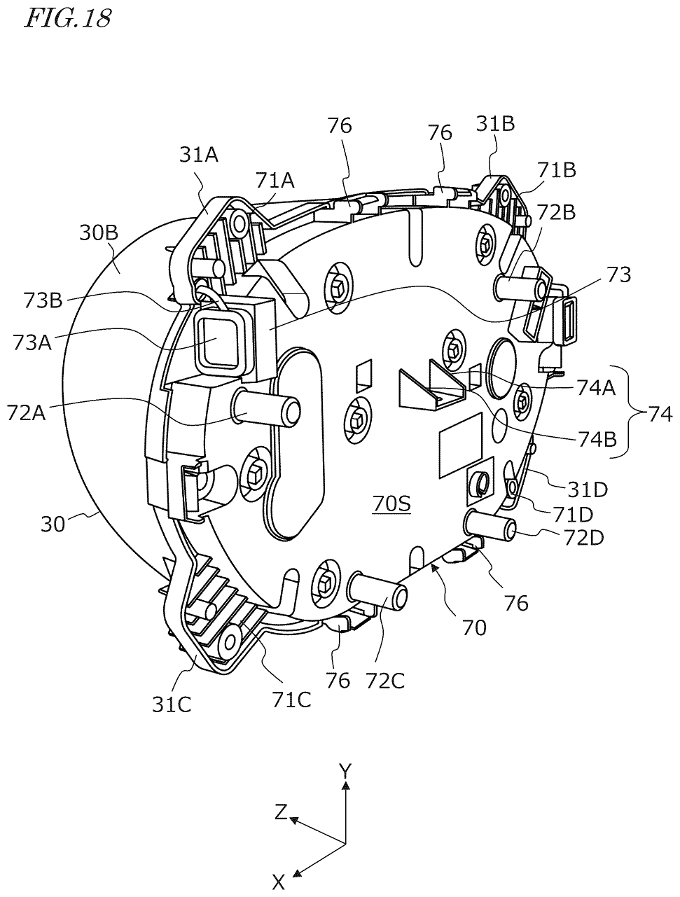

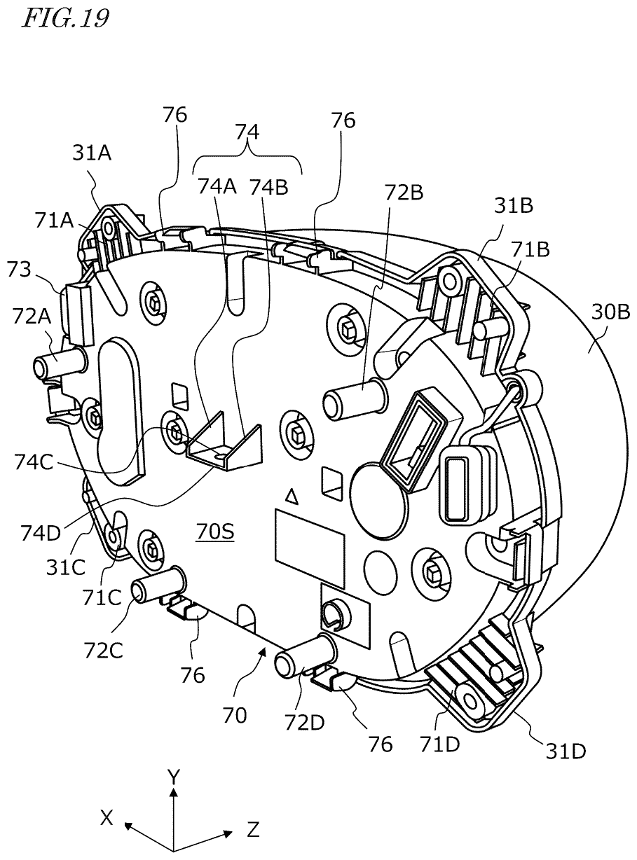

A back surface structure of the meter panel unit 100 of this example embodiment will be described below with reference to FIGS. 18 and 19. FIG. 18 is a perspective view illustrating a back surface of the meter panel unit 100. FIG. 19 is another perspective view of the back surface of the meter panel unit 100.

As illustrated in FIGS. 7B to 7D, which have been described above, the meter panel unit 100 includes the rear cover 70, which is positioned on the back surface side of the meter portion 10. A structure of the rear cover 70 in this example embodiment will be described below in detail.

Firstly, the rear cover 70 includes at least one back surface connector 73 with a connection direction that is tilted from the normal direction (the Z-axis direction) of a surface 70S of the rear cover 70. As used herein, the term “tilted” is intended to encompass orthogonality. The surface 70S may partially have roughness. Although in the example of FIG. 18, the number of back surface connectors 73 is one, the number of back surface connectors 73 may be at least two. The connection direction of the back surface connector 73 of FIG. 18 is parallel with the X-axis direction. In other words, the connection direction of the back surface connector 73 is orthogonal to the normal direction of the surface 70S of the rear cover 70. The back surface connector 73 is, for example, a connector that is to be connected to a camera cable from an in-vehicle camera.

With such a configuration, for example, a camera cable can be easily connected to or removed from the back surface connector 73 with the meter panel unit 100 remaining attached to the work vehicle. Specifically, when the meter cover 240 of FIG. 1B is detached with the meter panel unit 100 attached to the work vehicle, the back surface connector 73 can be accessed from an opened lateral space.

It should be noted that in the example of FIG. 18, when a certain cable is not connected to the back surface connector 73, a connection portion of the back surface connector 73 is blocked with a rubber cap 73A. The rubber cap 73A is in the shape of a rib that is recessed the connection portion side with the rubber cap 73A blocking the connection portion of the back surface connector 73. The rear cover 70 is provided with a retention tether 73B that flexibly connects the rubber cap 73A to the rear cover 70 so as to prevent the rubber cap 73A from being lost. The retention tether 73B is, for example, a rubber strap.

The retention tether 73B may be fixed to a fitting portion at which the rear cover 70 is fitted with the transparent cover 40. In the example of FIG. 18, the fixing section 71A of the rear cover 70 is fitted with the fixing section cover 31A of the transparent cover 40, which functions as a fitting portion, to which the retention tether 73B is fixed.

The rear cover 70 includes a binding section 74 for binding up a plurality of wire harnesses. In this example, the binding section 74 is positioned at a center of the rear cover 70. The rear cover 70 and the binding section 74 are integrally formed of a resin material. More specifically, the binding section 74 includes a pair of small plate pieces 74A and 74B protruding from the rear cover 70 in the normal direction (the Z-axis direction). The small plate pieces 74A and 74B are parallel with and opposite each other with a predetermined space interposed therebetween. The lower ends of the small plate pieces 74A and 74B are connected together by a bottom plate 74D having a through hole 74C. The through hole 74C has a size large enough to allow a plurality of wire harnesses to pass therethrough. A plurality of wire harnesses can be bound with the binding section 74 by being passed through the through hole 74C. This can prevent a plurality of wire harnesses from obstructing maintenance work, for example. The upper ends of the small plate pieces 74A and 74B are tilted from the normal direction of the surface 70S of the rear cover 70, so that a height (size in the Y-axis direction) of the small plate piece 74A, 74B decreases as one proceeds away from the surface 70S of the rear cover 70. A height of the binding section 74, or a height (size in the X-axis direction) of the small plate piece 74A, 74B, is 20 mm to 50 mm, for example.

The rear cover 70 includes a plurality of protrusions 76 configured to be fitted with a fastener or connector to which the meter panel unit 100 is to be attached. In the example of FIGS. 18 and 19, two protrusions 76 are provided at each of an upper and a lower portion of the rear cover 70. It should be noted that the positions and number of protrusions are not limited to this. Each protrusion 76 has a protruding portion (fitting lug). The meter panel unit 100 can be fixed to the meter cover 240 of FIG. 1B by the protruding portions of the protrusions 76 fitting into recessed portions (holes to be fitted with the fitting lugs) that are provided in the meter cover 240 and match the shape of the protruding portion. The rear cover 70 also includes at least three, preferably four protrusions 72A, 72B, 72C, and 72D that protrude from the surface 70S, for example. The tips of the protrusions 72A, 72B, 72C, and 72D are positioned on the same plane (imaginary plane). The protrusions 72A, 72B, 72C, and 72D are positioned so as to form a predetermined space between such a plane and the surface 70S of the rear cover 70.

A height (size in the X-axis direction) of each of the protrusions 72A, 72B, 72C, and 72D is, for example, 25 mm to 60 mm. Each of the protrusions 72A, 72B, 72C, and 72D may be positioned at a distance within the range of, for example, at least about 100 mm, preferably at least about 120 mm, from the center of the surface 70S of the rear cover 70.

The rear cover 70 and the protrusions 72A, 72B, 72C, and 72D are integrally formed of, for example, a resin material. The height of the above predetermined space formed between the same plane on which the tips of the protrusions 72A, 72B, 72C, and 72D are positioned and the surface of 70S of the rear cover 70 is greater than the heights of all protruding portions provided on the surface 70S such as the binding section 74 and the back surface connector 73. Therefore, for example, the meter panel unit 100 can, for example, be stably placed on a flat work bench by the protrusions 72A, 72B, 72C, and 72D without being interfered by the binding section 74 or the back surface connector 73. As a result, it may be easy to perform work such as assembly, wiring, or maintenance.

Example embodiments of the present disclosure are widely applicable to various work vehicles that are used in smart agriculture.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A meter panel unit for a work vehicle, comprising:
a meter portion including a first analog meter and a second analog meter each including a pointer, and a display between the first and second analog meters;
a wall surface provided on a display surface side of the meter portion to surround the first and second analog meters and the display; and
a transparent cover opposite a display surface of the meter portion; wherein
the wall surface includes a visor region positioned above the first and second analog meters and the display; and
the transparent cover includes a concave surface.

2. The meter panel unit of claim 1, wherein the transparent cover includes a front surface section including the concave surface, and a side surface section extending from the front surface section along an outer side of the wall surface.

3. The meter panel unit of claim 2, wherein the side surface section of the transparent cover covers an outer side of the wall surface around an entire periphery thereof.

4. The meter panel unit of claim 1, wherein with the meter panel unit attached to the work vehicle, the transparent cover is tilted toward an operator of the work vehicle as viewed from a normal direction of the meter portion.

5. The meter panel unit of claim 1, wherein the concave surface of the transparent cover has a uniform curvature in each of a horizontal direction and a vertical direction orthogonal to the horizontal direction.

6. The meter panel unit of claim 1, wherein a height of the visor region from the meter portion is at least about 40 mm.

7. The meter panel unit of claim 1, further comprising
a rear cover positioned on a back surface side of the meter portion; wherein
the rear cover includes at least one back surface connector with a connection direction tilted from a normal direction of the rear cover.

8. The meter panel unit of claim 7, wherein the at least one back surface connector is a connector configured to be connected to a camera cable, and a connection direction of the connector is orthogonal to a normal direction.

9. The meter panel unit of claim 1, further comprising:
a rear cover positioned on a back surface side of the meter portion; wherein
the rear cover includes a binding section configured to bind up a plurality of wire harnesses.

10. The meter panel unit of claim 9, wherein the binding section is positioned at a center portion of the rear cover.

11. The meter panel unit of claim 1, further comprising:
a rear cover positioned on a back surface side of the meter portion;
wherein
the rear cover includes at least one fixing section including a bolt hole into which a bolt to fix the transparent cover is inserted; and
the at least one fixing section is positioned within a frame including a circumscribed rectangle that touches an outer shape of the meter panel unit.

12. The meter panel unit of claim 11, wherein the at least one fixing section includes four fixing sections protruding toward four corners of the circumscribed rectangle.

13. The meter panel unit of claim 1, further comprising:
a rear cover positioned on a back surface side of the meter portion;
wherein
the rear cover includes a surface including at least three protrusions protruding toward a back surface side; and
tips of the at least three protrusions are positioned on a same plane, and configured to provide a predetermined space between the plane and the surface.

14. The meter panel unit of claim 13, wherein the rear cover and the protrusions are integrally formed of a resin material.

15. The meter panel unit of claim 1, further comprising:
a rear cover positioned on a back surface side of the meter portion: and
a decorative ring provided along an edge of the transparent cover;
wherein
the decorative ring is fixed to the rear cover with the decorative ring on the transparent cover.

16. The meter panel unit of claim 1, further comprising:
a rear cover positioned on a back surface side of the meter portion;
wherein
the rear cover includes at least two fixing sections including a bolt hole into which a bolt to fix the transparent cover is inserted; and
the bolt hole of one of the at least two fixing sections has a size and shape different from a size and a shape of the bolt holes of the other fixing sections.

17. A work vehicle comprising:
the meter panel unit of claim 1.
